(19) United States
(12) Patent Application Publication
(10) Pub. No.: US 2007/0075952 A1
(43) Pub. Date: Apr. 5, 2007

(54) Voltage driver

(76) Inventors: Yoshihisa Hamahashi, Osaka (JP); Tomoya Ishikawa, Osaka (JP); Tetsuo Asada, Osaka (JP); Yoshito Date, Shiga (JP); Yasuyuki Doi, Kyoto (JP)

Correspondence Address: MCDERMOTT WILL & EMERY LLP, 600 13TH STREET, N.W., WASHINGTON, DC, 20005-3096, US

(21) Appl. No.: 11/526,059

(22) Filed: Sep. 25, 2006

(30) Foreign Application Priority Data
Sep. 30, 2005 (JP) 2005-288130

(51) Int. Cl. G09G 3/36

(52) U.S. Cl. 345/89

(57) ABSTRACT

Each of first and second decoders outputs two voltages each having a voltage value equal to any one of a plurality of gray-level voltages according to gray-level data as two selection voltages or outputs any two of the plurality of gray-level voltages according to gray-level data as the two selection voltages. A connection switching circuit associates one of the first and second decoders with a first differential amplifier and the other decoder with a second differential amplifier. An output switching circuit associates one of the first and second differential amplifiers with a first output node and the other differential amplifier with a second output node. Each of the first and second differential amplifiers synthesizes selection voltages output from the decoder associated with the differential amplifier to generate a driving voltage and outputs the generated driving voltage to the output node associated with the differential amplifier.

### BACKGROUND OF THE INVENTION

1. Field of the Invention

The present invention relates to a voltage driver for outputting a driving voltage according to gray-scale data and, more specifically, to a display driver used for voltage-driven display panels, and the like.

2. Description of the Prior Art

In recent years, the screen size, definition, and number of gray levels of flat panel displays have been increasing along with reductions in panel thickness, weight, and costs. Under such circumstances, display drivers have been required to have an improved evenness in display quality by reducing variations among a plurality of output terminals. As the number of gray levels increases due to a larger number of gray levels of data to be displayed on a display panel, the circuit area of a decoder for selecting gray-level voltages increases. When compared with a decoder where the number of gray levels of display data is “6 bits”, the circuit area of a decoder where the number of gray levels of display data is “8 bits” is 4 times larger, and the circuit area of a decoder where the number of gray levels of display data is “10 bits” is 8 times larger. As the circuit area of the decoder and relevant circuits increases due to an increase in the number of gray levels, various costs also increase.

A solution to such problems is selecting two gray-level voltages from one piece of display data by a decoder and then generating one gray-level voltage from the two selected gray-level voltages using a 2-input/1-output operational amplifier. This solution can increase the number of gray levels without increasing the circuit area of the decoder.

A structure of a conventional voltage driver is shown in FIG. 11. The conventional voltage driver includes n input latches L901-1 to L901-n (n is a natural number), n output latches L902-1 to L902-n, n decoders D903-1 to D903-n, and n operational amplifiers A905-1 to A905-n. The n decoders D903-1 to D903-n are continually provided such that adjacent decoders exist in the vicinity of each other. The n operational amplifiers A905-1 to A905-n are continually provided such that adjacent operational amplifiers exist in the vicinity of each other. Each of n output nodes N900-1 to N900-n is connected to a voltage-driven element (not shown) for driving one corresponding pixel of a display panel. Each of n pieces of display data DATA(1) to DATA(2k) corresponds to one pixel of the display panel and is indicative of the gray level of the pixel. In this driver, driving voltages selected according to display data DATA(1) to DATA(2k) are supplied to the n output nodes N900-1 to N900-n for driving the display panel.

An operation of the voltage driver shown in FIG. 11 is now described. The input latch L901-1 acquires display data DATA(1) to output the acquired display data DATA(1). The output latch L902-1 acquires display data DATA(1) output from the input latch L901-1 at a predetermined timing to output the acquired display data DATA(1).

The decoder D903-1 receives display data DATA(1) output from the output latch L902-1 to select one or two gray-level voltages among (m/2) gray-level voltages V0, V2, V4, . . . , V(m−3), V(m−1) and outputs two selection voltages VA and VB according to the selected one or two gray-level voltages. Selection voltage VA is output from an output terminal 903-1A. Selection voltage VB is output from an output terminal 903-1B. Gray-level voltages V₀ to V₍ₘ₋₁₎ respectively correspond to the gray levels of the display data. For example, gray-level voltage V₀ corresponds to gray level “0”, gray-level voltage V₂ corresponds to gray level “2”, and gray-level voltage V₍ₘ₋₁₎ corresponds to gray level “m−1”. That is, none of the decoders D903-1 to D903-n receives gray-level voltage V₁ (V₀<V₁<V₂) corresponding to gray level “1”.

The operational amplifier A905-1 receives selection voltage VA at an input terminal 905-1C and selection voltage VB at an input terminal 905-1D. The operational amplifier A905-1 outputs as a driving voltage an intermediate voltage between two selection voltages VA and VB. For example, if both of two selection voltages VA and VB are equal to gray-level voltage V₀, a driving voltage equivalent to gray-level voltage V₀ is output. If one of two selection voltages VA and VB is equivalent to gray-level voltage V₀ and the other is equivalent to gray-level voltage V₂, a driving voltage equivalent to gray-level voltage V₁ is output.

The driving voltage generated by the operational amplifier A905-1 is output to the output node N900-1.

Thus, the number of gray-level voltages input to each of the decoders D903-1 to D903-n can be halved, and therefore, the number of transistors included in the decoder can be reduced. As a result, the increase of the circuit area of the decoder can be suppressed.

However, wires connecting respective decoders and operational amplifiers to a power supply (not shown) each have a resistance value (wire resistance) per unit length. This results in a variation in supply voltages supplied to respective circuits. When supply voltages supplied to respective circuits vary, voltages output from the circuits have errors according to the variation in supply voltages. Further, wires for supplying gray-level voltages to the decoders also have wire resistances, and therefore, there is a possibility that the voltage values of the gray-level voltages supplied to the decoders also vary. For example, since the decoder D903-1 is physically most distant from the decoder D903-n, the voltage values of the gray-level voltages supplied to the decoder D903-1 can be greatly different from the voltage values of the gray-level voltages supplied to the decoder D903-n.

Further, two wires connecting a decoder and a corresponding operational amplifier (for example, a wire connecting the output terminal 903-1A and the input terminal 905-1C and a wire connecting the output terminal 903-1B and the input terminal 905-1D) also have wire resistances. Therefore, two selection voltages VA and VB output from the decoder have errors according to the wire resistances.

Transistors included in each of the decoders and operational amplifiers have variations in characteristics among one another. The voltage output from each of these circuits includes an error according to the variations in characteristics. Especially, each operational amplifier is greatly affected by the variations in characteristics.

As described above, the variation in supply voltages supplied to respective circuits and the variations in characteristics of transistors included in each circuit cause an error in each of n driving voltages. That is, n driving voltages vary. The variation of the driving voltages results in uneven display quality over an entire display panel. Especially when the variation of the driving voltages is large among adjacent pixels, the adjacent pixels have greatly different brightnesses, which results in a severe deterioration in display quality.

### SUMMARY OF THE INVENTION

An objective of the present invention is to improve the evenness in display quality by averaging the errors of driving voltages such that the variation of the driving voltages is reduced.

According to one aspect of the present invention, a voltage driver includes a first decoder, a second decoder, first and second differential amplifier circuits, a first connection switching circuit, and an output switching circuit. The first decoder outputs two selection voltages according to first gray-level data. The second decoder outputs two selection voltages according to second gray-level data. The first connection switching circuit associates one of the first and second decoders with the first differential amplifier circuit and the other decoder with the second differential amplifier circuit. The output switching circuit associates one of the first and second differential amplifier circuits with a first output node and the other differential amplifier circuit with a second output node in conjunction with the association by the first connection switching circuit. Each of the first and second decoders selects any one of a plurality of gray-level voltages according to the gray-level data to output, as the two selection voltages, two voltages each having a voltage value equal to the selected gray-level voltage or selects any two of the plurality of gray-level voltages according to the gray-level data to output the two selected gray-level voltage as the two selection voltages. Each of the first and second differential amplifier circuits synthesizes two selection voltages from the decoder associated with the differential amplifier circuit by the first connection switching circuit at a predetermined ratio to generate a driving voltage and outputs the generated driving voltage to the output node associated with the differential amplifier circuit by the output switching circuit.

In the above voltage driver, errors in the driving voltages can be averaged. Therefore, the evenness in display quality can be improved without deteriorating the display quality while suppressing an increase of the circuit area of a decoder for fine gradation display as compared with the conventional voltage drivers.

Each of the first connection switching circuit and the output switching circuit has a first connection mode and a second connection mode. In the first connection mode, the first connection switching circuit associates the first decoder with the first differential amplifier circuit and associates the second decoder with the second differential amplifier circuit, and the output switching circuit associates the first differential amplifier circuit with the first output node and associates the second differential amplifier circuit with the second output node. In the second connection mode, on the other hand, the first connection switching circuit associates the first decoder with the second differential amplifier circuit and associates the second decoder with the first differential amplifier circuit, and the output switching circuit associates the first differential amplifier circuit with the second output node and associates the second differential amplifier circuit with the first output node.

Preferably, the first connection switching circuit includes a first input section, a second input section, a first output section, and a second output section. The first input section receives two selection voltages from the first decoder. The second input section receives two selection voltages from the second decoder. The first output section outputs the two selection voltages received by one of the first and second input sections. The second output section outputs the two selection voltages received by the other one of the first and second input sections. The first differential amplifier circuit receives the two selection voltages from the first output section of the first connection switching circuit. The second differential amplifier circuit receives the two selection voltages from the second output section of the first connection switching circuit.

The above-described voltage driver further includes a first output latch, a second output latch, a third output latch, a fourth output latch, a fifth output latch, a sixth output latch, third to sixth decoders, an input switching circuit, third to sixth differential amplifier circuits, a second connection switching circuit, and a third connection switching circuit. The first output latch acquires the first display data. The second output latch acquires the second display data. The third output latch acquires the third display data. The fourth output latch acquires the fourth display data. The fifth output latch acquires the fifth display data. The sixth output latch acquires the sixth display data. The input switching circuit associates the first to sixth output latches with the first to sixth decoders on a one-to-one basis. The second connection switching circuit associates one of the third and fourth decoders with the third differential amplifier circuit and associates the other decoder with the fourth differential amplifier circuit. The third connection switching circuit associates one of the fifth and sixth decoders with the fifth differential amplifier circuit and associates the other decoder with the sixth differential amplifier circuit. The output switching circuit associates the first to sixth differential amplifier circuits with the first and second output nodes and third to sixth output nodes on a one-to-one basis in conjunction with the association by the input switching circuit and the association by the first to third connection switching circuits. Each of the first to sixth decoders selects any one of a plurality of gray-level voltages according to gray-level data acquired by the output latch associated with the decoder by the input switching circuit to output two voltages each having a voltage value equal to the selected gray-level voltage as two selection voltages or selects any two of the plurality of gray-level voltages according to the gray-level data acquired by the output latch associated with the decoder by the input switching circuit to output the two selected gray-level voltages as the two selection voltages. Each of the first and second differential amplifier circuits synthesizes two selection voltages from the decoder associated with the differential amplifier circuit by the first connection switching circuit at a predetermined ratio to generate a driving voltage and outputs the generated driving voltage to the output node associated with the differential amplifier by the output switching circuit. Each of the third and fourth differential amplifier circuits synthesizes two selection voltages from the decoder associated with the differential amplifier circuit by the second connection switching circuit at a predetermined ratio to generate a driving voltage and outputs the generated driving voltage to the output node associated with the differential amplifier by the output switching circuit. Each of the fifth and sixth differential amplifier circuits synthesizes two selection voltages from the decoder associated with the differential amplifier circuit by the third connection switching circuit at a predetermined ratio to generate a driving voltage and outputs the generated driving voltage to the output node associated with the differential amplifier by the output switching circuit.

In the above-described voltage driver, for example, variations in driving voltages can be averaged for each of R-, G-, and B-components.

Preferably, the first decoder and the second decoder are physically adjacent to each other. The first differential amplifier circuit and the second differential amplifier circuit are physically adjacent to each other. The input switching circuit has a first connection mode and a second connection mode. In the first connection mode, the input switching circuit associates the first output latch with the first decoder and the second output latch with the second decoder. In the second connection mode, the input switching circuit associates the first output latch with the second decoder and the second output latch with the first decoder. The first connection switching circuit has a third connection mode and a fourth connection mode. In the third connection mode, the first connection switching circuit associates the first decoder with the first differential amplifier circuit and the second decoder with the second differential amplifier circuit. In the fourth connection mode, the first connection switching circuit associates the first decoder with the second differential amplifier and the second decoder with the first differential amplifier circuit. The output switching circuit has a fifth connection mode and a sixth connection mode. In the fifth connection mode, the output switching circuit associates the first differential amplifier circuit with the first output node and the second differential amplifier circuit with the second output node. In the sixth connection mode, the output switching circuit associates the first differential amplifier circuit with the second output node and the second differential amplifier circuit with the first output node. When the input switching circuit is in the first connection mode and the first connection switching circuit is in the third connection mode or when the input switching circuit is in the second connection mode and the first connection switching circuit is in the fourth connection mode, the output switching circuit is in the fifth connection mode. When the input switching circuit is in the first connection mode and the first connection switching circuit is in the fourth connection mode or when the input switching circuit is in the second connection mode and the first connection switching circuit is in the third connection mode, the output switching circuit is in the sixth connection mode.

Preferably, the above-described voltage driver further includes first to sixth input latches, first and second output latches, third to sixth output latches, an input switching circuit, third to sixth decoders, third to sixth differential amplifier circuits, a second connection switching circuit, and a third connection switching circuit. The first input latch acquires the first gray-level data. The second input latch acquires the second gray-level data. The third input latch acquires the third gray-level data. The fourth input latch acquires the fourth gray-level data. The fifth input latch acquires the fifth gray-level data. The sixth input latch acquires the sixth gray-level data. The first output latch corresponds to the first decoder. The second output latch corresponds to the second decoder. The input switching circuit associates the first to sixth input latches with the first to sixth output latches on a one-to-one basis. The third to sixth decoders correspond to the third to sixth latches on a one-to-one basis. The second connection switching circuit associates one of the third and fourth decoders with the third differential amplifier circuit and associates the other decoder with the fourth differential amplifier circuit. The third connection switching circuit associates one of the fifth and sixth decoders with the fifth differential amplifier circuit and associating the other decoder with the sixth differential amplifier circuit. The output switching circuit associates the first to sixth differential amplifier circuits with the first and second output nodes and third to sixth output nodes on a one-to-one basis in conjunction with the association by the input switching circuit and the association by the first to third connection switching circuits. Each of the first to sixth output latches acquires gray-level data acquired by an input latch associated by the connection switching circuit in synchronization with a predetermined timing. Each of the first to sixth decoders selects any one of the plurality of gray-level voltages according to gray-level data acquired by the output latch associated with the decoder by the input switching circuit to output two voltages each having a voltage value equal to the selected gray-level voltage as the two selection voltages or selects any two of the plurality of gray-level voltages according to the gray-level data acquired by the output latch associated with the decoder by the input switching circuit to output the two selected gray-level voltages as the two selection voltages. Each of the first and second differential amplifier circuits synthesizes two selection voltages from the decoder associated with the differential amplifier circuit by the first connection switching circuit at a predetermined ratio to generate a driving voltage and outputs the generated driving voltage to the output node associated with the differential amplifier by the output switching circuit. Each of the third and fourth differential amplifier circuits synthesizes two selection voltages from the decoder associated with the differential amplifier circuit by the second connection switching circuit at a predetermined ratio to generate a driving voltage and outputs the generated driving voltage to the output node associated with the differential amplifier by the output switching circuit. Each of the fifth and sixth differential amplifier circuits synthesizes two selection voltages from the decoder associated with the differential amplifier circuit by the third connection switching circuit at a predetermined ratio to generate a driving voltage and outputs the generated driving voltage to the output node associated with the differential amplifier by the output switching circuit.

In the above-described voltage driver, the timing of data transfer from an output latch to a decoder and the timing of outputting data to an output node can be controlled. Therefore, the possibility of an error occurring in the decoder can be eliminated.

Preferably, the first decoder and the second decoder are physically adjacent to each other. The first differential amplifier circuit and the second differential amplifier circuit are physically adjacent to each other. The input switching circuit has a first connection mode and a second connection mode. In the first connection mode, the input switching circuit associates the first input latch with the first output latch and the second input latch with the second output latch. In the second connection mode, the input switching circuit associates the first input latch with the second output latch and the second input latch with the first output latch. The first connection switching circuit has a third connection mode and a fourth connection mode. In the third connection mode, the first connection switching circuit associates the first decoder with the first differential amplifier circuit and the second decoder with the second differential amplifier circuit. In the fourth connection mode, the first connection switching circuit associates the first decoder with the second differential amplifier and the second decoder with the first differential amplifier circuit. The output switching circuit has a fifth connection mode and a sixth connection mode. In the fifth connection mode, the output switching circuit associates the first differential amplifier circuit with the first output node and the second differential amplifier circuit with the second output node. In the sixth connection mode, the output switching circuit associates the first differential amplifier circuit with the second output node and the second differential amplifier circuit with the first output node. When the input switching circuit is in the first connection mode and the first connection switching circuit is in the third connection mode or when the input switching circuit is in the second connection mode and the first connection switching circuit is in the fourth connection mode, the output switching circuit is in the fifth connection mode. When the input switching circuit is in the first connection mode and the first connection switching circuit is in the fourth connection mode or when the input switching circuit is in the second connection mode and the first connection switching circuit is in the third connection mode, the output switching circuit is in the sixth connection mode.

Preferably, each of the first and second decoders has a first output terminal for outputting one of the two selection voltages and a second output terminal for outputting the other of the two selection voltages. Each of the first and second differential amplifier circuits has first and second input terminals and synthesizes a selection voltage input at the first input terminal and a selection voltage input at the second input terminal at a predetermined ratio to generate a driving voltage. The driver further includes a first supply switching circuit. The first supply switching circuit operates between one of the first and second decoders and a differential amplifier circuit associated with the decoder by the first connection switching circuit such that the first supply switching circuit supplies a selection voltage output from one of first and second output terminals of the decoder to a first input terminal of the differential amplifier circuit and supplies a selection voltage output from the other output terminal of the decoder to a second input terminal of the differential amplifier circuit.

In the above-described voltage driver, the errors in selection voltages input to two input terminals of a differential amplifier circuit can be averaged. Thus, the error in a driving voltage output from the differential amplifier circuit can be decreased. Therefore, the evenness in display quality can be further improved as compared with the conventional voltage drivers.

Preferably, the first supply switching circuit has a first connection mode and a second connection mode. In the first connection mode, the first supply switching circuit operates between one of the first and second decoders and a differential amplifier circuit associated with the decoder by the first connection switching circuit such that the first supply switching circuit supplies a selection voltage output from a first output terminal of the decoder to a first input terminal of the differential amplifier circuit and supplies a selection voltage output from a second output terminal of the decoder to a second input terminal of the differential amplifier circuit. In the second connection mode, the first supply switching circuit operates between one of the first and second decoders and a differential amplifier circuit associated with the decoder by the connection switching circuit such that the first supply switching circuit supplies a selection voltage output from a first output terminal of the decoder to a second input terminal of the differential amplifier circuit and supplies a selection voltage output from a second output terminal of the decoder to a first input terminal of the differential amplifier circuit.

Preferably, the above-described voltage driver further includes a second supply switching circuit. The second supply switching circuit operates between the other one of the first and second decoders and a differential amplifier circuit associated with the decoder by the first connection switching circuit such that the second supply switching circuit supplies a selection voltage output from one of first and second output terminals of the decoder to a first input terminal of the differential amplifier circuit and supplies a selection voltage output from the other output terminal of the decoder to a second input terminal of the differential amplifier circuit.

According to another aspect of the present invention, a voltage driver includes a decoder, a differential amplifier circuit, and a supply switching circuit. The decoder generates two selection voltages according to gray-level data and outputs one of the two generated selection voltages from a first output terminal and the other selection voltage from a second output terminal. The differential amplifier circuit has first and second input terminals. The differential amplifier circuit generates a driving voltage by synthesizing a voltage input at the first input terminal and a voltage input at the second input terminal at a predetermined ratio and outputs the generated driving voltage. The supply switching circuit supplies a selection voltage output from one of the first and second output terminals of the decoder to the first input terminal of the differential amplifier circuit and supplies a selection voltage output from the other output terminal of the decoder to the second input terminal of the differential amplifier circuit. The decoder selects any one of a plurality of gray-level voltages according to the gray-level data to output two voltages each having a voltage value equal to the selected gray-level voltage as the two selection voltages or selects any two of the plurality of gray-level voltages according to the gray-level data to output the two selected gray-level voltages as the two selection voltages.

In the above-described voltage driver, errors in selection voltages input to respective one of two input terminals of a differential amplifier circuit can be averaged. Therefore, the error in a driving voltage output from the differential amplifier circuit can be reduced. Thus, the evenness in display quality can be further improved as compared with the conventional voltage drivers.

Preferably, the supply switching circuit has a first connection mode and a second connection mode. In the first connection mode, the supply switching circuit supplies a selection voltage output from a first output terminal of the decoder to a first input terminal of the differential amplifier circuit and supplies a selection voltage output from a second output terminal of the decoder to a second input terminal of the differential amplifier circuit. In the second connection mode, the supply switching circuit supplies a selection voltage output from a first output terminal of the decoder to a second input terminal of the differential amplifier circuit and supplies a selection voltage output from a second output terminal of the decoder to a first input terminal of the differential amplifier circuit.

### BRIEF DESCRIPTION OF THE DRAWINGS

FIG. 1 shows an overall structure of a voltage driver according to embodiment 1 of the present invention.

FIG. 2 is an example of the internal structure of an operational amplifier shown in FIG. 1.

FIG. 3 shows an overall structure of a voltage driver according to embodiment 2 of the present invention.

FIG. 4 shows a variation of the voltage driver shown in FIG. 3.

FIG. 5 shows an overall structure of a voltage driver according to embodiment 3 of the present invention.

FIG. 6 illustrates the connections of connection switches shown in FIG. 5.

FIG. 7 illustrates the connections of supply switches in a voltage driver according to embodiment 4 of the present invention.

FIG. 8 shows a variation of the voltage driver according to embodiment 4 of the present invention.

FIG. 9 shows an overall structure of a voltage driver according to embodiment 5 of the present invention.

FIG. 10 shows an overall structure of a voltage driver according to embodiment 6 of the present invention.

FIG. 11 shows an overall structure of a conventional voltage driver.

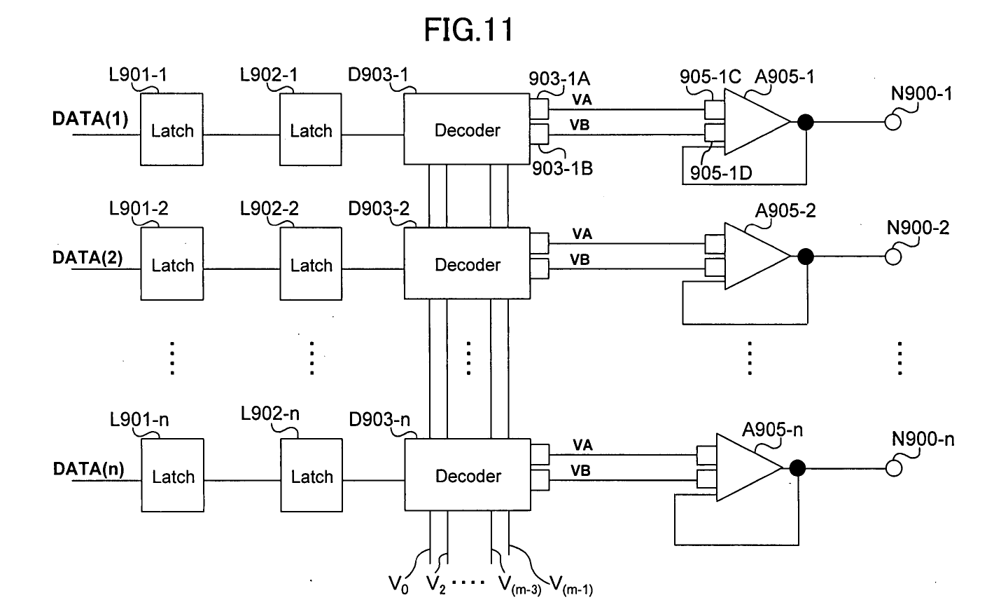

### DESCRIPTION OF THE PREFERRED EMBODIMENTS

Hereinafter, embodiments of the present invention will be described in detail with reference to the drawings. It should be noted that the same or equivalent elements are denoted by the same reference numerals, and the descriptions thereof will not be repeatedly provided.

(Embodiment 1)

<Structure>

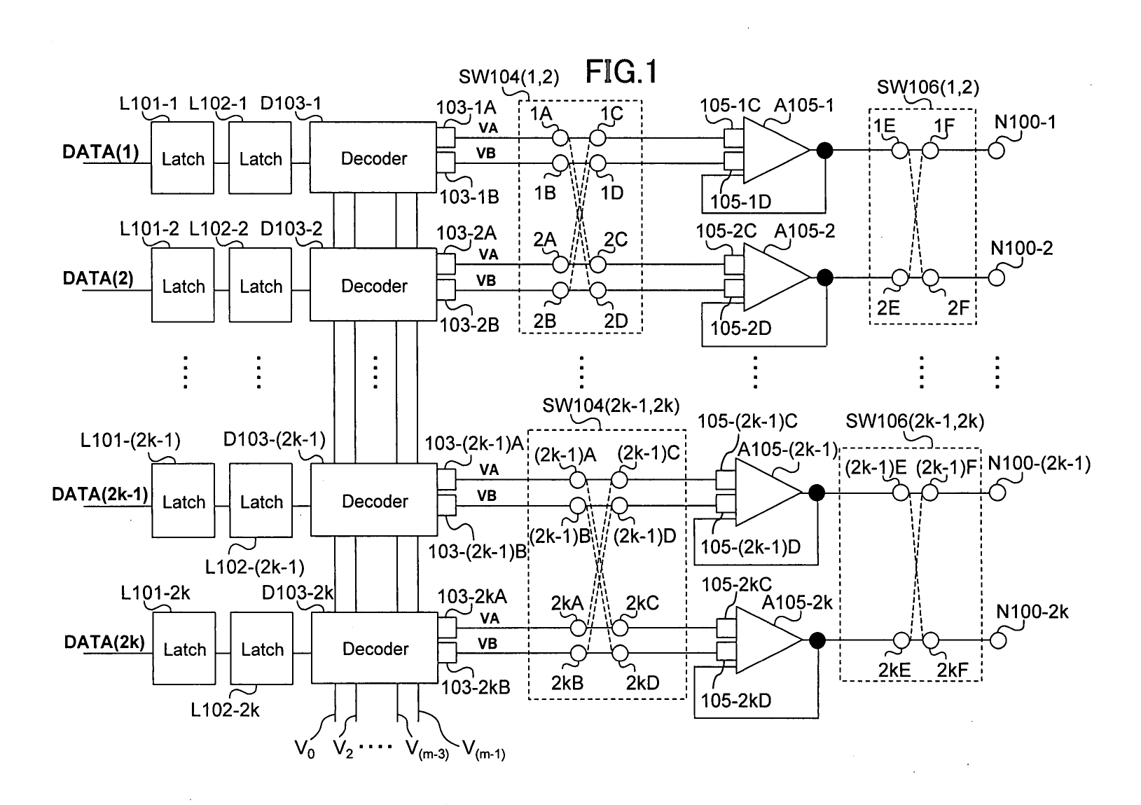

FIG. 1 shows an overall structure of a voltage driver according to embodiment 1 of the present invention. This driver includes 2k input latches L101-1 to L101-2k (k is a natural number), 2k output latches L102-1 to L102-2k, 2k decoders D103-1 to D103-2k, k connection switches SW104(1,2) to SW104(2k-1,2k), 2k operational amplifiers A105-1 to A105-2k, and k output switches SW106(1,2) to SW106(2k-1,2k). In this structure, m/2 gray-level voltages V₀, V₂, V₄, . . . , V₍ₘ₋₃₎, V₍ₘ₋1) are input to each of the 2k decoders (m is a natural number indicative of the number of gray levels).

This driver drives a display panel by supplying 2k driving voltages selected according to 2k pieces of display data DATA(1) to DATA(2k) to 2k output nodes N100-1 to N100-2k. Each of the 2k pieces of display data is indicative of the gray level of one pixel of the display panel. A driving voltage supplied to each of the 2k output nodes is supplied to a voltage-driven element for driving one pixel of the display panel.

The input latches L101-1 to L101-2k correspond to the display data DATA(1) to DATA(2k) on a one-to-one basis. The output latches L102-1 to L102-2k correspond to the input latches L101-1 to L101-2k on a one-to-one basis. The decoders D103-1 to D103-2k correspond to the output latches L102-1 to L102-2k on a one-to-one basis. The decoders D103-1 to D103-2k are continually provided such that adjacent decoders exist in the vicinity of each other. The operational amplifiers A105-1 to A105-2k correspond to the decoders D103-1 to D103-2k on a one-to-one basis. The operational amplifiers A105-1 to A105-2k are continually provided such that adjacent operational amplifiers exist in the vicinity of each other. Each of the connection switches SW104(1,2) to SW104(2k-1,2k) correspond to an odd-numbered decoder and operational amplifier and an even-numbered decoder and operational amplifier. For example, the connection switch SW104(1,2) corresponds to the decoder D103-1 and operational amplifier A105-1 and the decoder D103-2 and operational amplifier A105-2. Each of the output switches SW106(1,2) to SW106(2k−1,2k−1) correspond to an odd-numbered operational amplifier and output node and an even-numbered operational amplifier and output node. For example, the output switch SW106(1,2) corresponds to the operational amplifier A105-1 and output node N100-1 and the operational amplifier A105-2 and output node N100-2. The output nodes N100-1 to N100-2k correspond to the operational amplifiers A105-1 to A105-2k on a one-to-one basis.

This voltage driver is configured with the minimum unit including two input latches, two output latches, two decoders, one connection switch, two operational amplifiers, and one output switch. For example, the input latches L101-1 and L101-2, the output latches L102-1 and L102-2, the decoders D103-1 and D103-2, the connection switch SW104(1,2), the operational amplifiers A105-1 and A105-2, and the output switch SW106(1,2) constitute one minimum unit.

Each of the input latches L101-1 to L101-2k acquires a corresponding one of display data DATA(1) to DATA(2k) from an external device (e.g., a control LSI of the display panel) to output the acquired data. For example, the input latch L101-1 acquires display data DATA(1) to output the acquired display data DATA(1).

Each of the output latches L102-1 to L102-2k acquires display data output from a corresponding input latch according to a predetermined timing (e.g., a timing control signal used for display on the display panel) to output the acquired display data. For example, the output latch L102-1 acquires display data DATA(1) output from the input latch L101-1 to output the acquired display data DATA(1).

Each of the decoders D103-1 to D103-2k receives display data output from a corresponding output latch and selects one or two gray-level voltages from among the M/2 gray-level voltages according to the display data to output two selection voltages VA and VB which are determined according to the selected gray-level voltages. For example, the decoder D103-1 outputs selection voltages VA and VB according to display data DATA(1) output from the output latch L102-1. Herein, the decoder D103-1 outputs selection voltage VA and selection voltage VB from the output terminal 103-1A and the output terminal 103-1B, respectively.

Each of the connection switches SW104(1,2) to SW104(2k-1,2k) switches the connection of two corresponding decoders and two corresponding operational amplifiers. For example, the connection switch SW104(1,2) connects one of the decoders D103-1 and D103-2 to the operational amplifier A105-1 and the other decoder to the operational amplifiers A105-2.

Each of the operational amplifiers A105-1 to A105-2k receives two selection voltages VA and VB output from decoders connected by a corresponding connection switch. Each of the operational amplifiers A105-1 to A105-2k synthesizes the received selection voltages VA and VB at a predetermined ratio to generate a driving voltage. For example, the operational amplifier A105-1 receives selection voltages VA and VB from one of the decoders D103-1 and D103-2 which is connected to itself, i.e., the operational amplifier A105-1, by the connection switch SW104(1,2).

Each of the output switches SW106(1,2) to SW106(2k-1,2k) switches the connection of two corresponding operational amplifiers and two corresponding output nodes. For example, the output switch SW106(1,2) connects one of the operational amplifiers A105-1 and A105-2 to the output node N100-1 and the other operational amplifier to the output node N100-2.

<Decoder>

Next, the decoder D103-1 is specifically described.

Where the number of gray levels is “m”, a conventionally-employed decoder receives m gray-level voltages V₀, V₁, V₂, V₃, . . . , V₍ₘ₋₃₎, V₍ₘ₋₂₎, V₍ₘ₋₁₎. Herein, V₀<V_{1<V}₂<V₃< . . . <V₍ₘ₋₃₎<V₍ₘ₋₂)<V₍ₘ₋₁₎. Gray-level voltages V₀ to V₍ₘ₋₁₎ respectively correspond to the gray levels of display data. For example, gray-level voltage V₀ corresponds to “0”, gray-level voltage V₁ corresponds to “1”, and gray-level voltage V₍ₘ₋₁₎ corresponds to “m−1”.

On the other hand, where the number of gray levels is “m”, a decoder of this embodiment receives m/2 gray-level voltages V₀, V₂, V₄, . . . , V₍ₘ₋₃₎, V₍ₘ₋₁₎. That is, gray-level voltage V₀ corresponding to gray level “0” is input to the decoder, but gray-level voltage V₁ corresponding to gray level “1” is not input to the decoder. Among m gray-level voltages, voltages corresponding to the odd-numbered gray levels are not input to the decoder. (It should be noted that, in the descriptions provided herein, “m−1” is an even number.)

The decoder D103-1 selects one or two gray-level voltages from among m/2 gray-level voltages according to display data DATA(1). Specifically, if one of the m/2 gray-level voltages corresponds to display data DATA(1), the decoder D103-1 selects the gray-level voltage corresponding to display data DATA(1). For example, when the gray level indicated by display data DATA(1) is “2”, the decoder D103-1 selects gray-level voltage V₂. The decoder D103-1 outputs the selected gray-level voltage V₂ from the output terminals 103-1A and 103-1B. This means that two selection voltages VA and VB are output from the decoder D103-1. Each of selection voltages VA and VB corresponds to gray-level voltage V₂. If none of the m/2 gray-level voltages corresponds to display data DATA(1), the decoder D103-1 selects a gray-level voltage corresponding to “(gray level indicated by display data DATA(1))−“1” and a gray-level voltage corresponding to “(gray level indicated by display data DATA(1))+1”. For example, when the gray level indicated by display data DATA(1) is “1” , the decoder D103-1 selects gray-level voltage V₀ and gray-level voltage V₂. The decoder D103-1 outputs one of the selected two gray-level voltages from the output terminal 103-1A and outputs the other from the output terminal 103-1B. This means that two selection voltages VA and VB are output from the decoder D103-1. Selection voltage VA corresponds to gray-level voltage V₀, and selection voltage VB corresponds to gray-level voltage V₂.

Substantially the same process as that performed on the decoder D103-1 is also carried out on the decoder D103-2, so that selection voltages VA and VB are output from the output terminals 103-2A and 103-2B. In the other decoders, substantially the same process is also carried out. For example, in an odd-numbered decoder D103-(2k−1), the output terminal 103-(2k−1)A is equivalent to the output terminal 103-1A, and the output terminal 103-(2k−1)B is equivalent to the output terminal 103-1B. In an even-numbered decoder D103-2k, the output terminal 103-2kA is equivalent to the output terminal 103-2A, and the output terminal 103-2kB is equivalent to the output terminal 103-2B.

<Connection Switch>

Next, the connection switch SW104(1,2) is described in detail.

In the connection switch SW104(1,2), the terminal 1A is connected to the output terminal 103-1A of the decoder D103-1, the terminal 1B is connected to the output terminal 103-1B of the decoder D103-1, the terminal 1C is connected to the input terminal 105-1C of the operational amplifier A105-1, and the terminal 1D is connected to the input terminal 105-1D of the operational amplifier A105-1. The terminal 2A is connected to the output terminal 103-2A of the decoder D103-2, the terminal 2B is connected to the output terminal 103-2B of the decoder D103-2, the terminal 2C is connected to the input terminal 105-2C of the operational amplifier A105-2, and the terminal 2D is connected to the input terminal 105-2D of the operational amplifier A105-2.

The connection switch SW104(1,2) has the normal connection mode and the cross-connection mode. In the normal connection mode, the terminal 1A is connected to the terminal 1C, the terminal 1B is connected to the terminal 1D, the terminal 2A is connected to the terminal 2C, and the terminal 2B is connected to the terminal 2D. In the cross-connection mode, on the other hand, the terminal 1A is connected to the terminal 2C, the terminal 1B is connected to the terminal 2D, the terminal 2A is connected to the terminal 1C, and the terminal 2B is connected to the terminal 1D.

In the other connection switches, substantially the same process as that performed in the connection switch SW104(1,2) is also carried out. For example, in the connection switch SW104(2k−1,2k), the terminal (2k−1)A is equivalent to the terminal 1A, the terminal (2k−1)B is equivalent to the terminal 1B, the terminal (2k−1)C is equivalent to the terminal 1C, and the terminal (2k−1)D is equivalent to the terminal 1D. The terminal 2kA is equivalent to the terminal 2A, the terminal 2kB is equivalent to the terminal 2B, the terminal 2kC is equivalent to the terminal 2C, and the terminal 2kD is equivalent to the terminal 2D.

<Operational Amplifier>

Next, the operational amplifier A105-1 is described in detail.

The operational amplifier A105-1 has two input terminals 105-1C and 105-1D. The input terminal 105-1C receives the selection voltage output from the terminal 1C of the connection switch SW104(1,2). The input terminal 105-1D receives the selection voltage output from the terminal 1D of the connection switch SW104(1,2). If the selection voltages received at the input terminals 105-1C and 105-1D are equal, the operational amplifier A105-1 outputs a driving voltage equal to the selection voltages from the output terminals. For example, if each of the two selection voltages is equal to gray-level voltage V₀, the operational amplifier A105-1 outputs a driving voltage having a voltage value equal to gray-level voltage V₀ (a driving voltage equivalent to gray-level voltage V₀). If the selection voltages received at the input terminals 105-1C and 105-1D are different, the operational amplifier A105-1 outputs, from the output terminal, a driving voltage obtained by synthesizing the two selection voltages at a predetermined ratio. That is, the operational amplifier A105-1 outputs a driving voltage having a voltage value greater than selection voltage VA and smaller than selection voltage VB (herein, VA<VB). Since it is assumed herein that the synthesis ratio in the operational amplifier A105-1 is set to “1:1”, the operational amplifier A105-1 outputs the median voltage between the two selection voltages. That is, the operational amplifier A105-1 outputs a driving voltage equivalent to (“Selection Voltage VA”+“Selection Voltage VB”)/2. For example, if one of the two selection voltages is equivalent to gray-level voltage V₀ and the other is equivalent to gray-level voltage V₂, the operational amplifier A105-1 outputs a driving voltage equivalent to gray-level voltage V₁, which is equivalent to the median voltage between gray-level voltage V₀ and gray-level voltage V₂.

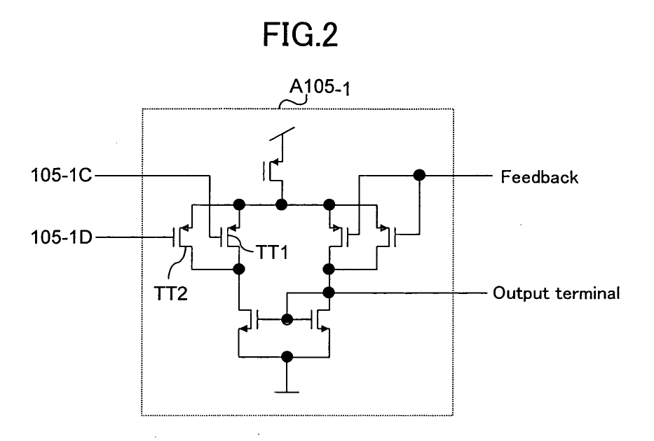

An example of the internal structure of the operational amplifier A105-1 is shown in FIG. 2. The operational amplifier A105-1 is a 2-input/1-output operational amplifier. For example, the synthesis ratio between the two selection voltages can be adjusted by adjusting the gate ratio between a transistor TT1, which receives at the gate the selection signal input at the input terminal 105-1C, and a transistor TT2, which receives at the gate the selection signal input at the input terminal 105-1D.

In the operational amplifier A105-2, substantially the same process as that performed in the operational amplifier A105-1 is also carried out, whereby a driving voltage obtained by synthesizing selection voltages input at the input terminals 105-2C and 105-2D at a predetermined ratio is output from the operational amplifier A105-2. Substantially the same process is also carried out in the other operational amplifiers. That is, in an odd-numbered operational amplifier A105-(2k−1), the input terminal 105-(2k−1)C is equivalent to the input terminal 105-1C, and the input terminal 103-(2k−1)C is equivalent to the input terminal 103-1C. In an even-numbered decoder D103-2k, the input terminal 105-2kA is equivalent to the input terminal 105-2A, and the input terminal 105-2kB is equivalent to the input terminal 105-2B.

<Output Switch>

Next, the output switch SW106(1,2) is described in detail.

In the output switch SW106(1,2), the terminal 1E is connected to the output terminal of the operational amplifier A105-1, the terminal 2E is connected to the output terminal of the operational amplifier A105-2, the terminal 1F is connected to the output node N100-1, and the terminal 2F is connected to the output node N100-2.

The output switch SW106(1,2) has the normal connection mode and the cross-connection mode. In the normal connection mode, the terminal 1E is connected to the terminal 1F, and the terminal 2E is connected to the terminal 2F. In the cross-connection mode, on the other hand, the terminal 1E is connected to the terminal 2F, and the terminal 2E is connected to the terminal 1F. Substantially the same process as that performed on the output switch SW106(1,2) is also carried out in the other switches. For example, in the output switch SW106(2k−1,2k), the terminal (2k−1)E corresponds to the terminal 1E, and the terminal (2k−1)F corresponds to the terminal 1F. The terminal 2kE corresponds to the terminal 2E, and the terminal 2kF corresponds to the terminal 2F.

<Switching of Connection Mode>

Switching of the connection mode by each of the output switches SW106(1,2) to SW106(2k−1,2k) is carried out in conjunction with the switching of the mode by the connection switches SW104(1,2) to SW104(2k−1,2k) which correspond to the output switches SW106(1,2) to SW106(2k−1,2k). When the connection switch SW104(1,2) enters the normal connection mode, the output switch SW106(1,2) also enters the normal connection mode. When the connection switch SW104(1,2) enters the cross-connection mode, the output switch SW106(1,2) enters the cross connection mode. The connection mode may be switched according to the switching of frames on the display panel or may be switched according to the switching of lines on the display panel.

<Operation>

Next, an operation of the voltage driver shown in FIG. 1 is described. Herein, an operation relating to display data DATA(1) and DATA(2) is described as a typical example.

[Normal Connection Mode]

When the normal connection mode is entered, in the connection switch SW104(1,2), the terminal 1A is connected to the terminal 1C, the terminal 1B is connected to the terminal 1D, the terminal 2A is connected to the terminal 2C, and the terminal 2B is connected to the terminal 2D. Therefore, the operational amplifier A105-1 generates a driving voltage according to two selection voltages from the decoder D103-1, and the operational amplifier A105-2 generates a driving voltage according to two selection voltages from the decoder D103-2.

In the output switch SW106(1,2), the terminal 1E is connected to the terminal 1F, and the terminal 2E is connected to the terminal 2F. Therefore, the driving voltage generated by the operational amplifier A105-1 is supplied to the output node N100-1, and the driving voltage generated by the operational amplifier A105-2 is supplied to the output node N100-2.

In this way, in the normal connection mode, the driving voltage corresponding to display data DATA(1) is generated by “the operational amplifier A105-1”, and the driving voltage corresponding to display data DATA(2) is generated by “the operational amplifier A105-2”.

[Cross-connection Mode]

When the cross-connection mode is entered, in the connection switch SW104(1,2), the terminal 1A is connected to the terminal 2C, the terminal 1B is connected to the terminal 2D, the terminal 2A is connected to the terminal 1C, and the terminal 2B is connected to the terminal 1D. Therefore, the operational amplifier A105-1 generates a driving voltage according to two selection voltages from the decoder D103-2, and the operational amplifier A105-2 generates a driving voltage according to two selection voltages from the decoder D103-1.

In the output switch SW106(1,2), the terminal 1E is connected to the terminal 2F, and the terminal 2E is connected to the terminal 1F. Therefore, the driving voltage generated by the operational amplifier A105-1 is supplied to the output node N100-2, and the driving voltage generated by the operational amplifier A105-2 is supplied to the output node N100-1.

In this way, in the cross-connection mode, the driving voltage corresponding to display data DATA(1) is generated by “the operational amplifier A105-2”, and the driving voltage corresponding to display data DATA(2) is generated by “the operational amplifier A105-1”.

<Variations>

Where an error in the driving voltage output from the operational amplifier A105-1 is ΔV1 and an error in the driving voltage output from the operational amplifier A105-2 is ΔV2,
the error in the driving voltage received by the output node N100-1=(ΔV1+ΔV2)/2, and
the error in the driving voltage received by the output node N100-2=(ΔV1+ΔV2)/2.
That is, the errors in the driving voltages supplied to the output nodes N100-1 and N100-2 are averaged to be equal to each other. Thus, the evenness in display quality is improved.

<Effects>

As described above, in a voltage driver according to this embodiment, two signal route patterns in the driving circuit for generation of driving voltages allow averaging of errors in the driving voltages. Thus, the evenness in display quality is improved without deteriorating the display quality while suppressing an increase of the circuit area of a decoder for fine gradation display as compared with the conventional voltage drivers.

It should be noted that the same effects can be obtained even when a voltage driver is configured with the minimum unit including N input latches (N is a natural number equal to or greater than 3), N output latches, N decoders, one connection switch, N operational amplifiers, and one output switch.

(Embodiment 2)

<Variations in Decoder and Operational Amplifier>

A wire connecting a decoder and an operational amplifier has a resistance value per unit length. Further, transistors included in the decoder have variations in characteristics because of variations caused in the diffusion process. That is, an error occurs in each of selection voltages VA and VB input to the two input terminals of the operational amplifier. Meanwhile, transistors included in the operational amplifier also have variations in characteristics. Therefore, variations in selection voltages VA and VB input to the two input terminals of the operational amplifier can further increase the error in the driving voltage output from the operational amplifier.

<Structure>

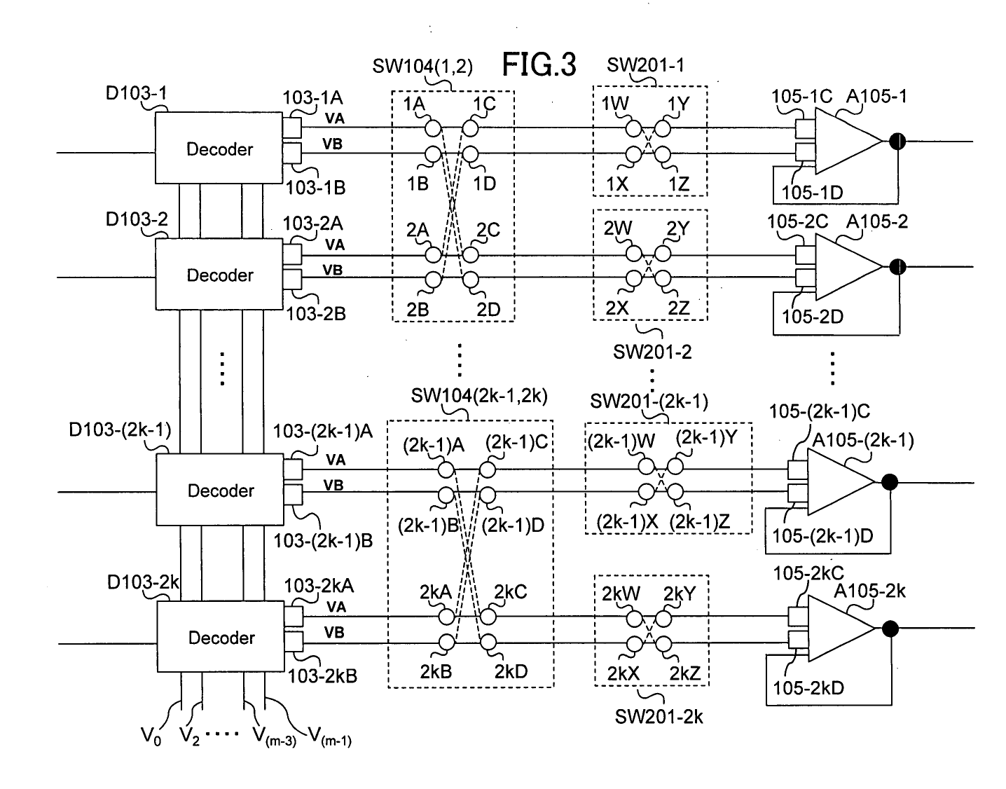

An overall structure of a voltage driver according to embodiment 2 of the present invention is illustrated in FIG. 3. This driver 2 includes 2k supply switches SW201-1 to SW201-2k in addition to the components of the voltage driver shown in FIG. 1. The supply switches SW201-1 to SW201-2k correspond to the operational amplifiers A105-1 to A105-2k on a one-to-one basis.

The supply switch SW201-1 is connected between the connection switch SW104(1,2) and the operational amplifier A105-1. The supply switch SW201-2 is connected between the connection switch SW104(1,2) and the operational amplifier A105-2. An odd-numbered supply switch SW201-(2k−1) is connected between the connection switch SW104(2k−1,2k) and the operational amplifier A105-(2k−1). An even-numbered supply switch SW201-2k is connected between the connection switch SW104(2k−1,2k) and the operational amplifier A105-2k.

<Supply Switch>

The supply switch SW201-1 has a terminal 1W connected to the terminal 1C of the connection switch SW104(1,2) and a terminal 1X connected to the terminal 1D of the connection switch SW104(1,2). The supply switch SW201-1 also has a terminal 1Y connected to the input terminal 105-1C of the operational amplifier A105-1 and a terminal 1Z connected to the input terminal 105-1D of the operational amplifier A105-1.

The supply switch SW201-1 has the normal connection mode and the cross-connection mode. In the normal connection mode, the terminal 1W is connected to the terminal 1Y, and the terminal 1X is connected to the terminal 1Z. In the cross-connection mode, on the other hand, the terminal 1W is connected to the terminal 1Z, and the terminal 1X is connected to the terminal 1Y.

In the supply switch SW201-2, substantially the same process as that performed on the supply switch SW201-1 is also carried out. The terminal 2W is equivalent to the terminal 1W, the terminal 2X is equivalent to the terminal 1X, the terminal 2Y is equivalent to the terminal 1Y, and the terminal 2Z is equivalent to the terminal 1Z. In an odd-numbered supply switch SW201-(2k−1), substantially the same process as that performed on the supply switch SW201-1 is also carried out. The terminal (2k−1)W is equivalent to the terminal 1W, the terminal (2k−1)X is equivalent to the terminal 1X, the terminal (2k−1)Y is equivalent to the terminal 1Y, and the terminal (2k−1)Z is equivalent to the terminal 1Z. In an even-numbered supply switch SW201-2k, substantially the same process as that performed on the supply switch SW201-2 is also carried out. The terminal 2kW is equivalent to the terminal 2W, the terminal 2kX is equivalent to the terminal 2X, the terminal 2kY is equivalent to the terminal 2Y, and the terminal 2kZ is equivalent to the terminal 2Z.

<Switching of Connection Mode>

The connection mode of the supply switches SW201-1 to SW201-2k may be switched according to the switching of frames on the display panel or may be switched according to the switching of lines on the display panel. Switching of the connection mode in the supply switches SW201-1 to SW201-2k may not necessarily be in synchronization with switching of the connection mode in each of the connection switches SW104(1,2) to SW104(2k−1,2k) or switching of the connection mode in each of the output switches SW106(1,2) to SW106(2k−1,2k).

<Operation>

Next, an operation of the voltage driver shown in FIG. 3 is described. This driver performs a process which will be described below in addition to the operation of the voltage driver shown in FIG. 1. Herein, an operation relating to display data DATA(1) is described as a typical example.

[Normal Connection Mode]

When the normal connection mode is entered, in the supply switch SW201-1, the terminal 1W is connected to the terminal 1Y, and the terminal 1X is connected to the terminal 1Z. Accordingly, the input terminal 105-1C of the operational amplifier A105-1 is supplied with selection voltage VA from the output terminal 103-1A of the decoder D103-1 or the output terminal 103-2A of the decoder D103-2. The input terminal 105-1D of the operational amplifier A105-1 is supplied with selection voltage VB from the output terminal 103-1B of the decoder D103-1 or the output terminal 103-2B of the decoder D103-2.

[Cross-connection Mode]

When the cross-connection mode is entered, in the supply switch SW201-1, the terminal 1W is connected to the terminal 1Z, and the terminal 1X is connected to the terminal 1Y. Accordingly, the input terminal 105-1C of the operational amplifier A105-1 is supplied with selection voltage VB from the output terminal 103-1B of the decoder D103-1 or the output terminal 103-2B of the decoder D103-2. The input terminal 105-1D of the operational amplifier A105-1 is supplied with selection voltage VA from the output terminal 103-1A of the decoder D103-1 or the output terminal 103-2A of the decoder D103-2.

<Variations>

Where an error in selection voltage VA output from the output terminal 103-1A of the decoder D103-1 is ΔVA and an error in selection voltage VB output from the output terminal 103-1B of the decoder D103-1 is ΔVB, in the operational amplifier A105-1,
the error in the selection voltage received by the transistor TT1=(ΔVA+ΔVB)/2, and
the error in the selection voltage received by the transistor TT2=(ΔVA+ΔVB)/2.
That is, the errors in the selection voltages received by the two input terminals 105-1A and 105-1B of the operational amplifier A105-1 are averaged to be equal to each other.

<Effects>

As described above, the errors in selection voltages input to two input terminals of an operational amplifier can be averaged. Thus, the error in a driving voltage output from the operational amplifier can be decreased. Therefore, the evenness in display quality can be further improved as compared with the conventional voltage drivers.

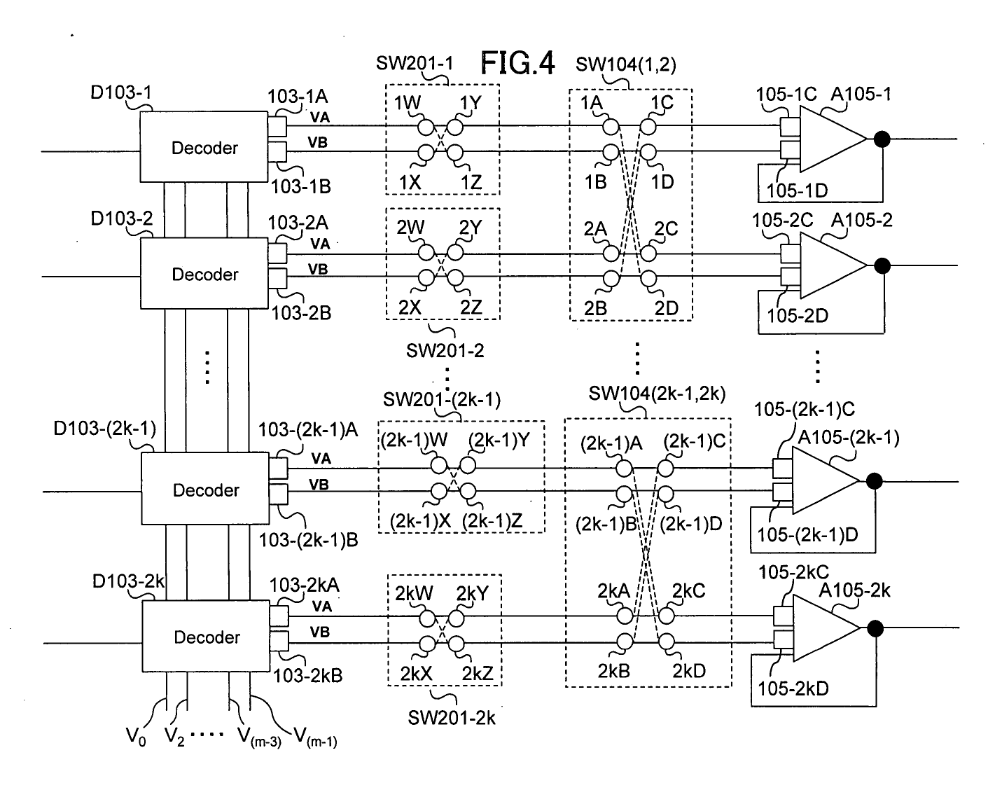

It should be noted that the same effects can be obtained even when, as shown in FIG. 4, the supply switches SW201-1 to SW201-2k are connected between the decoders D103-1 to D103-2k and the connection switches SW104(1,2) to SW104(2k−1,2k). For example, the same effects can be obtained even when, as shown in FIG. 4, the supply switch SW201-1 is connected between the decoder D103-1 and the connection switch SW104(1,2) and the supply switch SW201-2 is connected between the decoder D103-2 and the connection switch SW104(1,2).

(Embodiment 3)

<Structure>

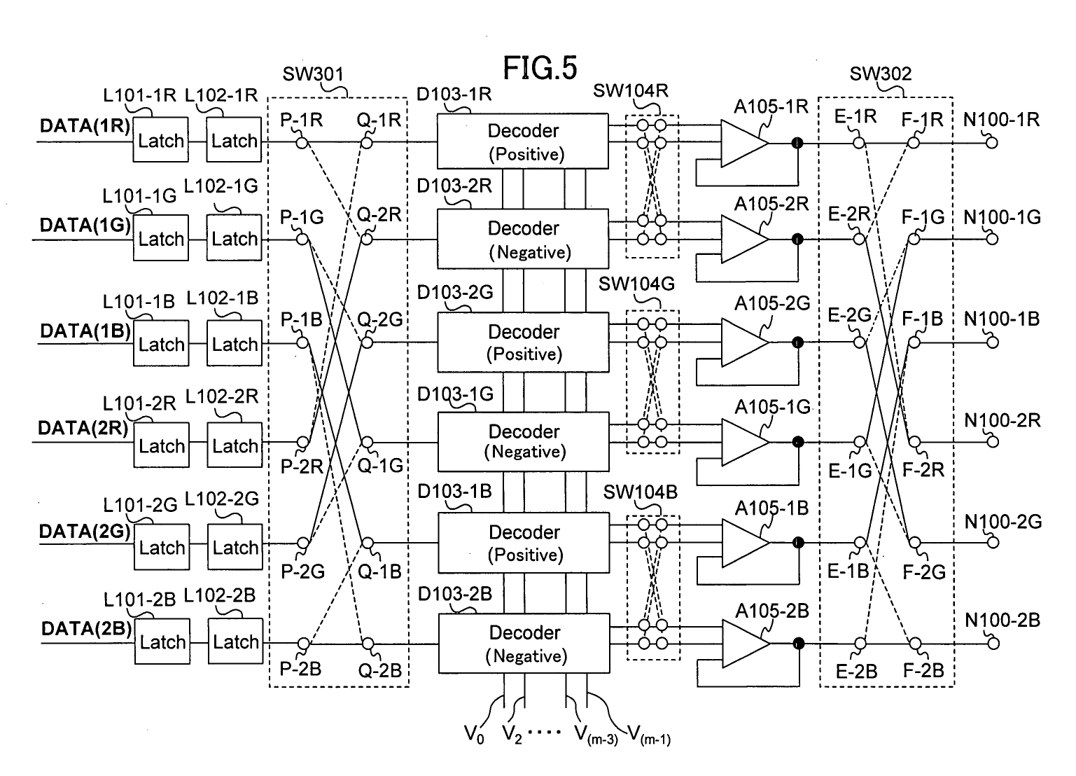

An overall structure of a voltage driver according to embodiment 3 of the present invention is illustrated in FIG. 5. This driver includes six input latches L101-1R, L101-1G, L101-1B, L101-2R, L101-2G, and L101-2B, six output latches L102-1R, L102-1G, L102-1B, L102-2R, L102-2G, and L102-2B, one input switch SW301, six decoders D103-1R, D103-2R, D103-2G, D103-1G, D103-1B, and D103-2B, 3 connection switches SW104R, SW104G, and SW104B, six operational amplifiers A105-1R, A105-2R, A105-2G, A105-1G, A105-1B, and A105-2B, and one output switch SW302.

In this example, the voltage driver drives adjacent two pixel blocks (first pixel block and second pixel block) in a display panel where a pixel for R-component, a pixel for G-component and a pixel for B-component constitute one pixel block. Display data DATA(1R) and DATA(2R) correspond to R-component of the pixel blocks. Display data DATA(1G) and DATA(2G) correspond to G-component of the pixel blocks. Display data DATA(1B) and DATA(2B) correspond to B-component of the pixel blocks. Each of output nodes N100-1R and N100-2R is connected to a voltage-driven element for driving a pixel for R-component. Each of output nodes N100-1G and N100-2G is connected to a voltage-driven element for driving a pixel for G-component. Each of output nodes N100-1B and N100-2B is connected to a voltage-driven element for driving a pixel for B-component. Herein, display data DATA(1R), DATA(1G) and DATA(1B) correspond to the first pixel block, and display data DATA(2R), DATA(2G) and DATA(2B) correspond to the second pixel block. The output nodes N100-1R, N100-1G and N100-1B correspond to the first pixel block, and the output nodes N100-2R, N100-2G and N100-2B correspond to the second pixel block.

The input latches L101-1R to L101-2B correspond to display data DATA(1R) to DATA(2B) on a one-to-one basis. The output latches L102-1R to L102-2B correspond to the input latches L101-1R to L101-2B on a one-to-one basis. The decoders D103-1R to D103-2B correspond to the output latches L102-1R to L102-2B on a one-to-one basis. The operational amplifiers A105-1R to A105-2B correspond to the decoders D103-1R to D103-2B on a one-to-one basis. The output nodes N100-1R to N100-2B correspond to the operational amplifiers A105-1R to A105-2B on a one-to-one basis. The connection switch SW104R corresponds to the decoders D103-1R and 103-2R and the operational amplifiers A105-1R and A105-2R. The connection switch SW104G corresponds to the decoders D103-2G and D103-1G and the operational amplifiers A105-2G and A105-1G. The connection switch SW104B corresponds to the decoders D103-1B and D103-2B and the operational amplifiers A105-1B and A105-2B.

Each of the six input latches L101-1R to L101-2B is the same as the input latch L101-1 shown in FIG. 1. Each of the six output latches L102-1R to L102-2B is the same as the output latch L102-1 shown in FIG. 1.

The input switch SW301 switches the connection of the six output latches L102-1R to L102-2B and the six decoders D103-1R to D103-2B.

Each of the six decoders D103-1R to D103-2B is the same as the decoder D103-1 of FIG. 1. The six decoders D103-1R to D103-2B are continually provided such that adjacent decoders exist in the vicinity of each other. It is assumed herein that the display panel (not shown) is driven according to an inversive driving method. In this case, each of the decoders D103-1R, D103-2G and D103-1B outputs a positive selection voltage, and each of the decoders D103-2R, D103-1G and D103-2B outputs a negative selection voltage.

Each of the connection switches SW104R, SW104G and SW104B is the same as the connection switch SW104(1,2) shown in FIG. 1.

Each of the six operational amplifiers A105-1R to A105-2B is the same as the operational amplifier A105-1 shown in FIG. 1. The six operational amplifiers A105-1R to A105-2B are continually provided such that adjacent operational amplifiers exist in the vicinity of each other.

The output switch SW302 switches the connection of the six operational amplifiers A105-1R to A105-2B and the output nodes N100-1R to N100-2B.

<Input Switch>

The input switch SW301 has a terminal P-1R connected to the output latch L102-1R, a terminal P-1G connected to the output latch L102-1G, a terminal P-1B connected to the output latch L102-1B, a terminal P-2R connected to the output latch L102-2R, a terminal P-2G connected to the output latch L102-2G, and a terminal P-2B connected to the output latch L102-2B. The input switch SW301 also has a terminal Q-1R connected to the decoder D103-1R, a terminal Q-2R connected to the decoder D103-2R, a terminal Q-2G connected to the decoder D103-2G, a terminal Q-1G connected to the decoder D103-1G, a terminal Q-1B connected to the decoder D103-1B, and a terminal Q-2B connected to the decoder D103-2B.

The input switch SW301 has the normal connection mode and the cross-connection mode. In the normal connection mode, the terminal P-1R is connected to the terminal Q-1R, the terminal P-1G is connected to the terminal Q-1G, the terminal P-1B is connected to the terminal Q-1B, the terminal P-2R is connected to the terminal Q-2R, the terminal P-2G is connected to the terminal Q-2G, and the terminal P-2B is connected to the terminal Q-2B. In the cross-connection mode, the terminal P-1R is connected to the terminal Q-2R, the terminal P-1G is connected to the terminal Q-2G, the terminal P-1B is connected to the terminal Q-2B, the terminal P-2R is connected to the terminal Q-1R, the terminal P-2G is connected to the terminal Q-1G, and the terminal P-2B is connected to the terminal Q-1B.

<Output Switch>

The output switch SW302 has a terminal E-1R connected to the output terminal of the operational amplifier A105-1R, a terminal E-2R connected to the output terminal of the operational amplifier A105-2R, a terminal E-2G connected to the output terminal of the operational amplifier A105-2G, a terminal E-1G connected to the output terminal of the operational amplifier A105-1G, a terminal E-1B connected to the output terminal of the operational amplifier A105-1B, and a terminal E-2B connected to the output terminal of the operational amplifier A105-2B. The output switch SW302 also has a terminal F-1R connected to the output node N100-1R, a terminal F-1G connected to the output node N100-1G, a terminal F-1B connected to the output node N100-1B, a terminal F-2R connected to the output node N100-2R, a terminal F-2G connected to the output node N100-2G, and a terminal F-2B connected to the output node N100-2B.

The output switch SW302 has the normal connection mode and the cross-connection mode. In the normal connection mode, the terminal E-1R is connected to the terminal F-1R, the terminal E-2R is connected to the terminal F-2R, the terminal E-2G is connected to the terminal F-2G, the terminal E-1G is connected to the terminal F-1G, the terminal E-1B is connected to the terminal F-1B, and the terminal E-2B is connected to the terminal F-2B. In the cross-connection mode, the terminal E-1R is connected to the terminal F-2R, the terminal E-2R is connected to the terminal F-1R, the terminal E-2G is connected to the terminal F-1G, the terminal E-1G is connected to the terminal F-2G, the terminal E-1B is connected to the terminal F-2B, and the terminal E-2B is connected to the terminal F-1B.

<Connection Switch>

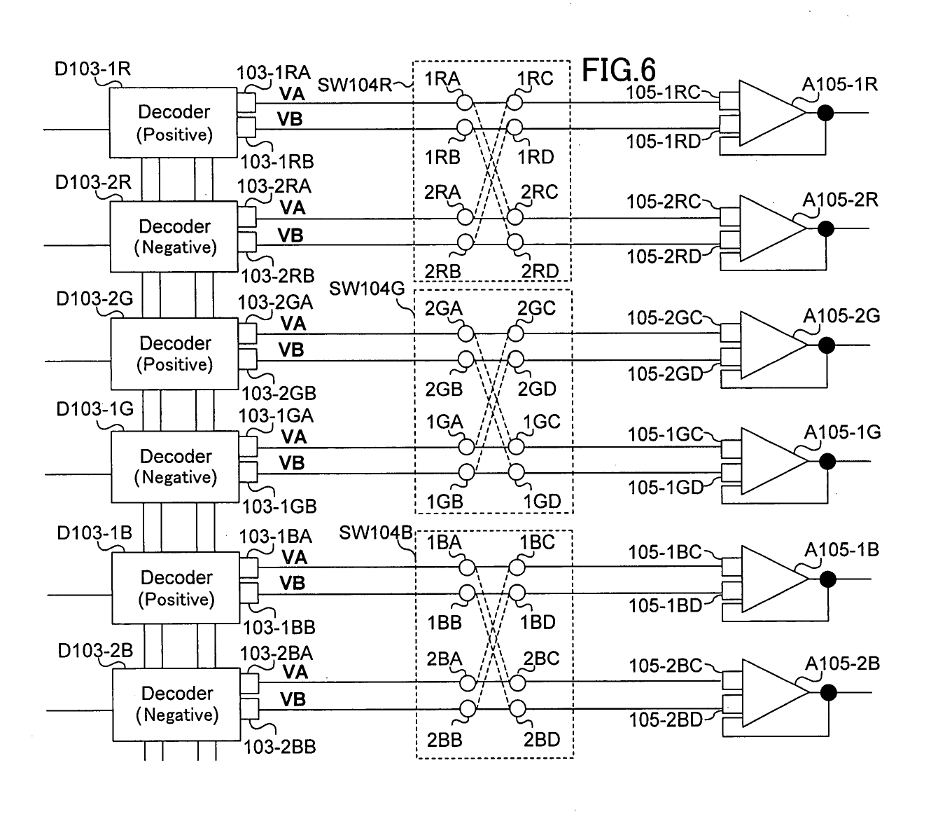

The internal structure of the connection switches SW104R, SW104G and SW104B of FIG. 5 is illustrated in FIG. 6.

The connection switch SW104R has terminals 1RA and 1RB connected to the output terminals 103-1RA and 103-1RB, respectively, of the decoder D103-1R and terminals 1RC and 1RD connected to the input terminals 105-1RC and 105-1RD, respectively, of the operational amplifier A105-1R. The connection switch SW104R also has terminals 2RA and 2RB connected to the output terminals 103-2RA and 103-2RB, respectively, of the decoder D103-2R and terminals 2RC and 2RD connected to the input terminals 105-2RC and 105-2RD, respectively, of the operational amplifier A105-2R.

The connection switch SW104G has terminals 2GA and 2GB connected to the output terminals 103-2GA and 103-2GB, respectively, of the decoder D103-2G and terminals 2GC and 2GD connected to the input terminals 105-2GC and 105-2GD, respectively, of the operational amplifier A105-2G. The connection switch SW104R also has terminals 1GA and 1GB connected to the output terminals 103-1GA and 103-1GB, respectively, of the decoder D103-1G and terminals 1GC and 1GD connected to the input terminals 105-1GC and 105-1GD, respectively, of the operational amplifier A105-1G.

The connection switch SW104B has terminals 1BA and 1BB connected to the output terminals 103-1BA and 103-1BB, respectively, of the decoder D103-1B and terminals 1BC and 1BD connected to the input terminals 105-1BC and 105-1BD, respectively, of the operational amplifier A105-1B. The connection switch SW104B also has terminals 2BA and 2BB connected to the output terminals 103-2BA and 103-2BB, respectively, of the decoder D103-2B and terminals 2BC and 2BD connected to the input terminals 105-2BC and 105-2BD, respectively, of the operational amplifier A105-2B.

In each of the connection switches SW104R to SW104B, the same operation as that performed on the connection switch SW104(1,2) shown in FIG. 1 is carried out. Herein, the terminals 1RA, 2GA and 1BA are equivalent to the terminal 1A, the terminals 1RB, 2GB and 1BB are equivalent to the terminal 1B, the terminals 1RC, 2GC and 1BC are equivalent to the terminal 1C, and the terminals 1RD, 2GD and 1BD are equivalent to the terminal 1D. The terminals 2RA, 1GA and 2BA are equivalent to the terminal 2A, the terminals 2RB, 1GB and 2BB are equivalent to the terminal 2B, the terminals 2RC, 2GC and 2BC are equivalent to the terminal 2C, and the terminals 2RD, 2GD and 2BD are equivalent to the terminal 2D.

<Switching of Connection Mode>

The connection switches SW104R, SW104G and SW104B operate in conjunction with one another to be in the same connection mode. For example, when the connection switch SW104R is in the normal connection mode, the connection switches SW104G and SW104B are also in the normal connection mode.

Switching of the connection mode by the output switch SW302 is carried out in conjunction with switching of the connection mode by each of the input switch SW301 and the connection switches SW104R to SW104B. Specifically, when the input switch SW301 is in “the normal connection mode” and the connection switches SW104R to SW104B are in “the normal connection mode”, or when the input switch SW301 is in “the cross-connection mode” and the connection switches SW104R to SW104B are in “the cross-connection mode”, the output switch SW302 is in “the normal connection mode”. On the other hand, when the input switch SW301 is in “the normal connection mode” and the connection switches SW104R to SW104B are in “the cross-connection mode”, or when the input switch SW301 is in “the cross-connection mode” and the connection switches SW104R to SW104B are in “the normal connection mode”, the output switch SW302 is in “the cross-connection mode”.

The connection mode may be switched according to the switching of frames on the display panel or may be switched according to the switching of lines on the display panel.

<Operation>

Next, an operation of the voltage driver shown in FIG. 5 is described. Herein, an operation relating to display data DATA(1R) and DATA(2R) is described as a typical example.

[Case 1]

First, a case where the connection switch SW104R is in “the normal connection mode” is described.

In this case, when the input switch SW301 is in “the normal connection mode”, the decoder D103-1R outputs two selection voltages according to display data DATA(1R) output from the output latch L102-1R. The operational amplifier A105-1R outputs a driving voltage according to the two selection voltages output from the decoder D103-1R. The decoder D103-2R outputs two selection voltages according to display data DATA(2R) output from the latch L102-2R. The operational amplifier A105-2R outputs a driving voltage according to the two selection voltages output from the decoder D103-2R. Since the output switch SW302 is in “the normal connection mode” at this point in time, the driving voltage output from the operational amplifier A105-1R is supplied to the output node N100-1R. The driving voltage output from the operational amplifier A105-2R is supplied to the output node N100-2R.

When the input switch SW301 is in “the cross-connection mode”, the decoder D103-1R outputs two selection voltages according to display data DATA(2R) output from the output latch L102-2R. The operational amplifier A105-1R outputs a driving voltage according to the two selection voltages output from the decoder D103-1R. The decoder D103-2R outputs two selection voltages according to display data DATA(1R) output from the latch L102-1R. The operational amplifier A105-2R outputs a driving voltage according to the two selection voltages output from the decoder D103-2R. Since the output switch SW302 is in “the cross-connection mode” at this point in time, the driving voltage output from the operational amplifier A105-1R is supplied to the output node N100-2R. The driving voltage output from the operational amplifier A105-2R is supplied to the output node N100-1R.

[Case 2]

Next, a case where the connection switch SW104R is in “the cross-connection mode” is described.

When the input switch SW301 is in the “normal connection mode”, the decoder D103-1R outputs two selection voltages according to display data DATA(1R) output from the output latch L102-1R. The operational amplifier A105-1R outputs a driving voltage according to the two selection voltages output from the decoder D103-2R. The decoder D103-2R outputs two selection voltages according to display data DATA(2R) output from the latch L102-2R. The operational amplifier A105-2R outputs a driving voltage according to the two selection voltages output from the decoder D103-1R. Since the output switch SW302 is in “the cross-connection mode” at this point in time, the driving voltage output from the operational amplifier A105-1R is supplied to the output node N100-2R. The driving voltage output from the operational amplifier A105-2R is supplied to the output node N100-1R.

When the input switch SW301 is in “the cross-connection mode”, the decoder D103-1R outputs two selection voltages according to display data DATA(2R) output from the output latch L102-2R. The operational amplifier A105-1R outputs a driving voltage according to the two selection voltages output from the decoder D103-2R. The decoder D103-2R outputs two selection voltages according to display data DATA(1R) output from the latch L102-1R. The operational amplifier A105-2R outputs a driving voltage according to the two selection voltages output from the decoder D103-1R. Since the output switch SW302 is in “the normal connection mode” at this point in time, the driving voltage output from the operational amplifier A105-1R is supplied to the output node N100-1R. The driving voltage output from the operational amplifier A105-2R is supplied to the output node N100-2R.

Thus, in any of the connection modes, a driving voltage determined according to display data DATA(1R) is supplied to the output node N100-1R, and a driving voltage determined according to display data DATA(2R) is supplied to the output node N100-2R.

<Variations>

Since the decoder D103-1R and the decoder D103-2R exist in the vicinity of each other, the effects of a variation in gray-level voltages, a variation in supply voltages, and variations in transistor characteristics are not greatly different between the decoders D103-1R and D103-2R. Since the operational amplifier A105-1R and the operational amplifier A105-2R exist in the vicinity of each other, the effects of a variation in supply voltages and variations in transistor characteristics are not greatly different between the operational amplifiers A105-1R and A105-2R.

Between the decoders D103-2G and D103-1G (or between the decoders D103-1B and D103-2B), the effects of a variation in gray-level voltages, a variation in supply voltages, and variations in transistor characteristics are not greatly different as are not in the decoders D103-1R and D103-2R. Between the operational amplifiers A105-2G and A105-1G (or between the operational amplifiers A105-1B and A105-2B), the effects of a variation in supply voltages and variations in transistor characteristics are not greatly different as are not in the operational amplifier A105-1R and A105-2R.

<Effects>

As described above, the variations in driving voltages can be averaged for each of R-, G-, and B-components.

Decoders (and operational amplifiers) corresponding to the respective color components are positioned in the vicinity of one another. Therefore, the variation of driving voltages supplied to adjacent pixel blocks can be suppressed for each of R-, G-, and B-components. For example, the decoder D103-1R corresponding to R-component of the first pixel block and the decoder D103-2R corresponding to R-component of the second pixel block which is adjacent to the first pixel block are positioned in the vicinity of each other. With this arrangement, a variation occurring between a driving voltage corresponding to R-component of the first pixel block and a driving voltage corresponding to R-component of the second pixel block can be suppressed. Thus, the evenness in display quality can be further improved.

Each of the connection switches SW104R, SW104G and SW104B is associated with two decoders and two operational amplifiers in this embodiment but may be associated with N decoders and N operational amplifiers.

(Embodiment 4)

<Structure>

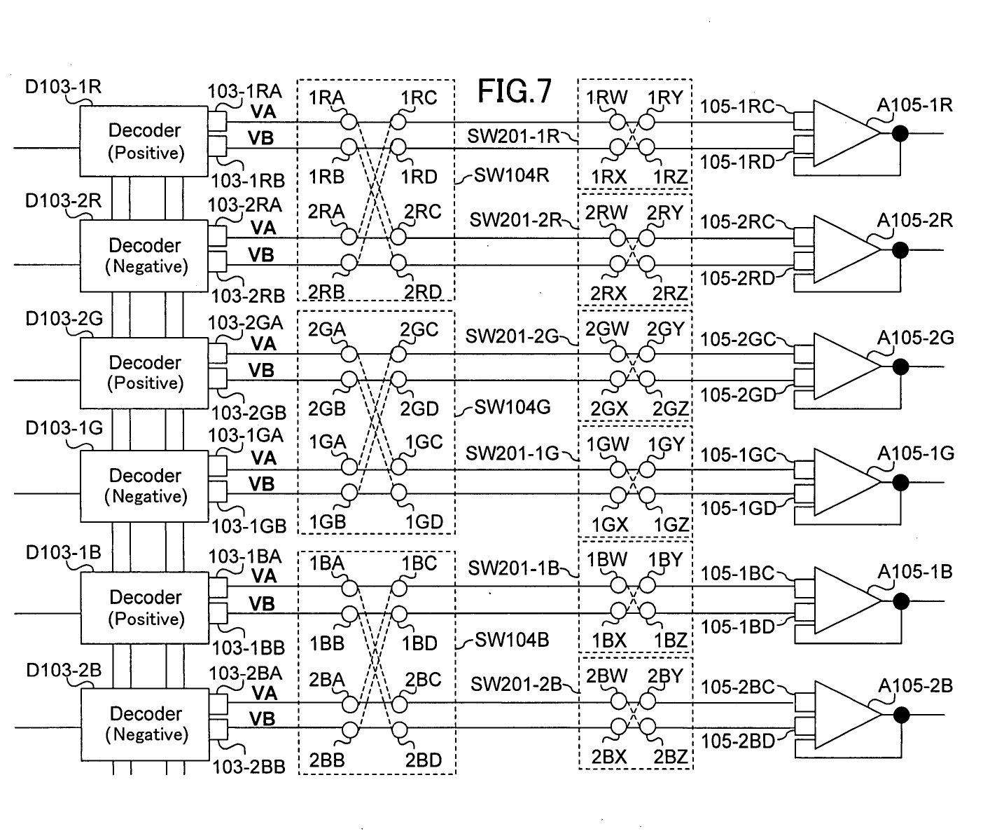

A voltage driver according to embodiment 4 of the present invention includes six supply switches SW201-1R, SW201-2R, SW201-2G, SW201-1G, SW201-1B, and SW201-2B shown in FIG. 7 in addition to the components of the voltage driver shown in FIG. 5. The other components are the same as those of the driver of FIG. 5. The supply switches SW201-1R to SW201-2B correspond to the operational amplifiers A105-1R to A105-2B on a one-to-one basis. Each of the supply switches SW201-1R to SW201-2B is the same as the supply switch SW201-1 shown in FIG. 3.

<Supply Switch>

The internal structure of the supply switches SW201-1R to SW201-2B is illustrated in FIG. 7.

The supply switch SW201-1R has terminals 1RW, 1RX, 1RY and 1RZ and is connected between the connection switch SW104R and the operational amplifier A105-1R. The supply switch SW201-2R has terminals 2RW, 2RX, 2RY and 2RZ and is connected between the connection switch SW104R and the operational amplifier A105-2R.

The supply switch SW201-2G has terminals 2GW, 2GX, 2GY and 2GZ and is connected between the connection switch SW104G and the operational amplifier A105-2G. The supply switch SW201-1G has terminals 1GW, 1GX, 1GY and 1GZ and is connected between the connection switch SW104G and the operational amplifier A105-1G.

The supply switch SW201-1B has terminals 1BW, 1BX, 1BY and 1BZ and is connected between the connection switch SW104B and the operational amplifier A105-1B. The supply switch SW201-2B has terminals 2BW, 2BX, 2BY and 2BZ and is connected between the connection switch SW104B and the operational amplifier A105-2B.

The supply switches SW201-1R to SW201-2B performs the same process as that carried out by the supply switch SW201-1 of FIG. 3. For example, the supply switch SW201-1R has the normal connection mode and the cross-connection mode. In the normal connection mode, the terminal 1RW is connected to the terminal 1RY, and the terminal 1RX is connected to the terminal 1RZ. In the cross-connection mode, the terminal 1RW is connected to the terminal 1RZ, and the terminal 1RX is connected to the terminal 1RY.

<Switching of Connection Mode>

The connection mode of the supply switches SW201-1R to SW201-2B may be switched according to the switching of frames on the display panel or may be switched according to the switching of lines on the display panel. Switching of the connection mode in the supply switches SW201-1R to SW201-2B may not necessarily be in synchronization with switching of the connection mode in each of the input switch SW301, output switch SW302, connection switches SW104R to SW104B.

<Operation>

Next, an operation of the voltage driver of this embodiment is described. The voltage driver of this embodiment performs a process which will be described below in addition to the operation of the voltage driver shown in FIG. 5. Herein, an operation relating to display data DATA(1) is described as a typical example.

[Normal Connection Mode]

When the supply switch SW201-1R is in “the normal connection mode”, the input terminal 105-1RC of the operational amplifier A105-1R is supplied with selection voltage VA from the output terminal 103-1RA of the decoder D103-1R or from the output terminal 103-2RA of the decoder D103-2R, and the input terminal 105-1RD of the operational amplifier A105-1R is supplied with selection voltage VB from the output terminal 103-1RB of the decoder D103-1R or from the output terminal 103-2RB of the decoder D103-2R.

[Cross-connection Mode]

When the supply switch SW201-1R is in “the normal connection mode”, the input terminal 105-1RC of the operational amplifier A105-1R is supplied with selection voltage VB from the output terminal 103-1RB of the decoder D103-1R or from the output terminal 103-2RB of the decoder D103-2R, and the input terminal 105-1RD of the operational amplifier A105-1R is supplied with selection voltage VA from the output terminal 103-1RA of the decoder D103-1R or from the output terminal 103-2RA of the decoder D103-2R.

<Effects>

As described above, the selection voltages input to the input terminals of the operational amplifiers can be averaged. Therefore, errors in driving voltages output from the operational amplifiers can be averaged. Thus, the evenness in display quality can be further improved as compared with the conventional voltage drivers.

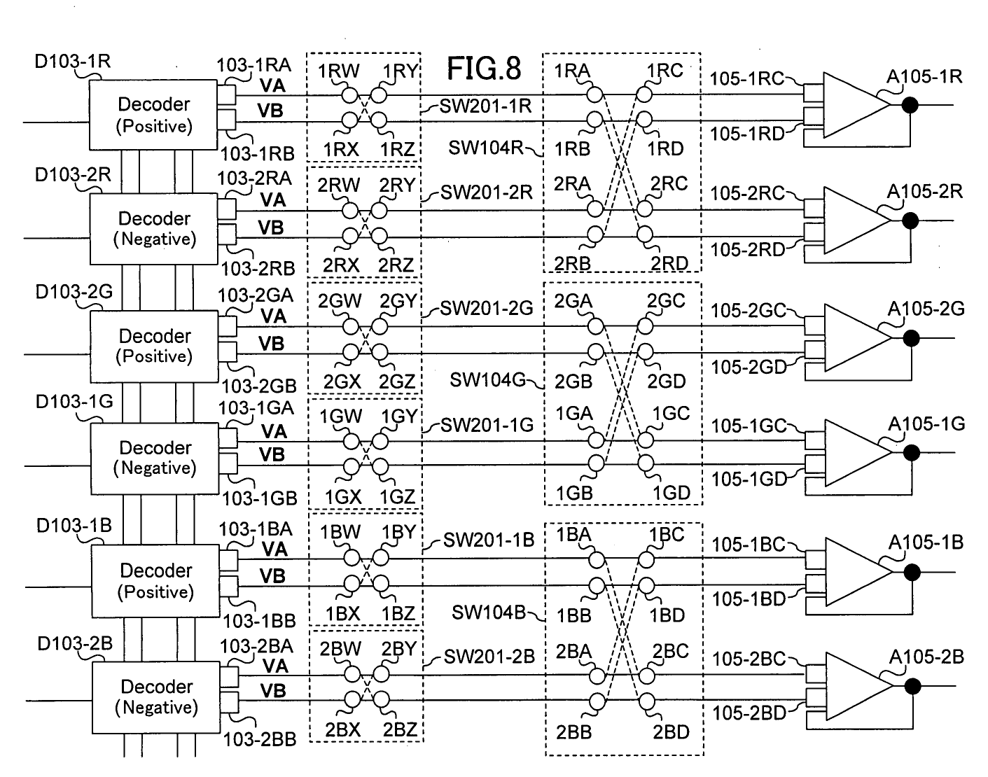

It should be noted that the same effects can be obtained even when, as shown in FIG. 8, the supply switches SW201-1R to SW201-2B are connected between the decoders D103-1R to D103-2B and the connection switches SW104R to SW104B. For example, the supply switch SW201-1R may be connected between the decoder D103-1R and the connection switch SW104R, and the supply switch SW201-2R may be connected between the decoder D103-2R and the connection switch SW104R.

(Embodiment 5)

<Structure>

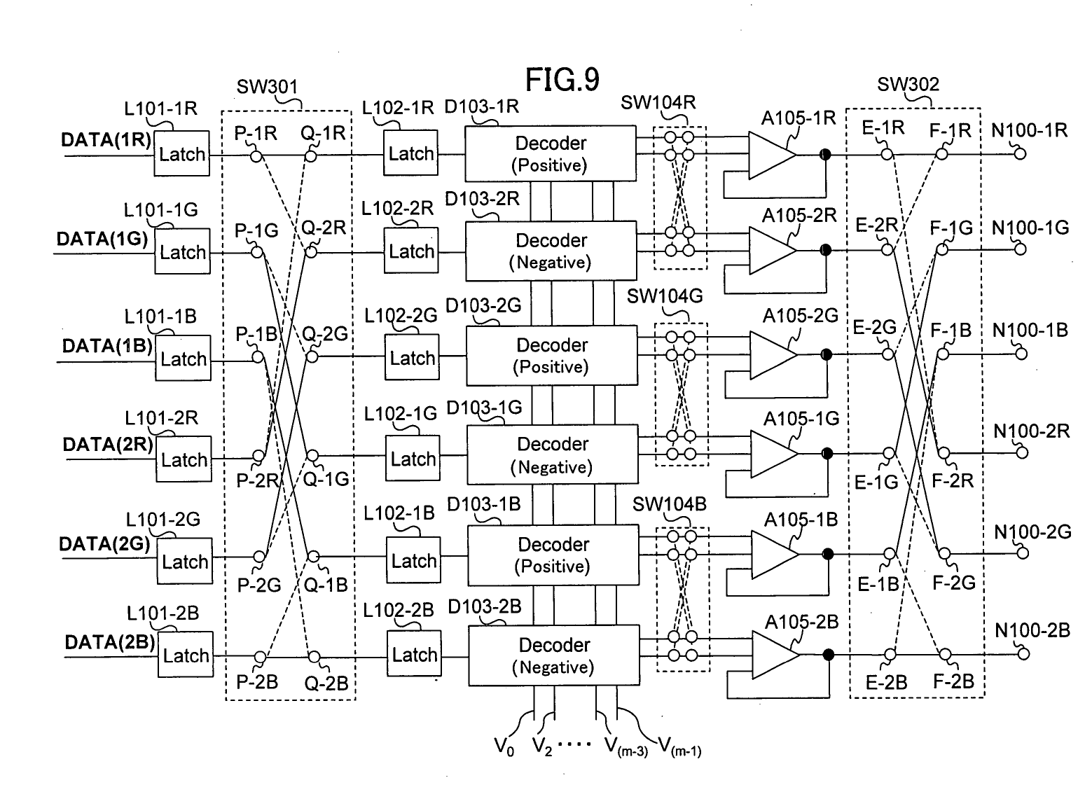

An overall structure of a voltage driver according to embodiment 5 of the present invention is illustrated in FIG. 9. In this driver, the input switch SW301 is connected between the input latches L101-1R to L101-2B and the output latches L102-1R to L102-2B. The other parts of the structure are the same as those of FIG. 5. The input switch SW301 has a terminal P-1R connected to the input latch L101-1R, a terminal P-1G connected to the input latch L101-1G, a terminal P-1B connected to the input latch L101-1B, a terminal P-2R connected to the input latch L101-2R, a terminal P-2G connected to the input latch L101-2G, and a terminal P-2B connected to the input latch L101-2B. The input switch SW301 also has a terminal Q-1R connected to the output latch L102-1R, a terminal Q-2R connected to the output latch L102-2R, a terminal Q-2G connected to the output latch L102-2G, a terminal Q-1G connected to the output latch L102-1G, a terminal Q-1B connected to the output latch L102-1B, and a terminal Q-2B connected to the output latch L102-2B.

<Operation>

Next, an operation of the voltage driver shown in FIG. 9 is described. Herein, an operation relating to display data DATA(1R) and DATA(2R) is described as a typical example.

[Case 1]

First, a case where the connection switch SW104R is in “the normal connection mode” is described.

In this case, when the input switch SW301 is in “the normal connection mode”, the output latch L102-1R outputs display data DATA(1R) input from the input latch L101-1R. The operational amplifier A105-1R outputs a driving voltage according to display data DATA(1R). The output latch L102-2R outputs display data DATA(2R) input from the input latch L101-2R. The operational amplifier A105-2R outputs a driving voltage according to display data DATA(2R). Since the output switch SW302 is in “the normal connection mode” at this point in time, the driving voltage output from the operational amplifier A105-1R is supplied to the output node N100-1R. The driving voltage output from the operational amplifier A105-2R is supplied to the output node N100-2R.

When the input switch SW301 is in “the cross-connection mode”, the output latch L102-1R outputs display data DATA(2R) input from the input latch L101-2R. The operational amplifier A105-1R outputs a driving voltage according to display data DATA(2R). The output latch L102-2R outputs display data DATA(1R) input from the input latch L101-1R. The operational amplifier A105-2R outputs a driving voltage according to display data DATA(1R). Since the output switch SW302 is in “the cross-connection mode” at this point in time, the driving voltage output from the operational amplifier A105-1R is supplied to the output node N100-2R. The driving voltage output from the operational amplifier A105-2R is supplied to the output node N100-1R.

[Case 2]

Next, a case where the connection switch SW104R is in “the cross-connection mode” is described.

When the input switch SW301 is in the “normal connection mode”, the output latch L102-1R outputs display data DATA(1R) input from the input latch L101-1R. The operational amplifier A105-2R outputs a driving voltage according to display data DATA(1R). The output latch L102-2R outputs display data DATA(2R) input from the input latch L101-2R. The operational amplifier A105-1R outputs a driving voltage according to display data DATA(2R). Since the output switch SW302 is in “the cross-connection mode” at this point in time, the driving voltage output from the operational amplifier A105-1R is supplied to the output node N100-2R. The driving voltage output from the operational amplifier A105-2R is supplied to the output node N100-1R.

When the input switch SW301 is in “the cross-connection mode”, the output latch L102-1R outputs display data DATA(2R) input from the input latch L101-2R. The operational amplifier A105-2R outputs a driving voltage according to display data DATA(2R). The output latch L102-2R outputs display data DATA(1R) input from the input latch L101-1R. The operational amplifier A105-1R outputs a driving voltage according to display data DATA(1R). Since the output switch SW302 is in “the normal connection mode” at this point in time, the driving voltage output from the operational amplifier A105-1R is supplied to the output node N100-1R. The driving voltage output from the operational amplifier A105-2R is supplied to the output node N100-2R.

Thus, in any of the connection modes, a driving voltage determined according to display data DATA(1R) is supplied to the output node N100-1R, and a driving voltage determined according to display data DATA(2R) is supplied to the output node N100-2R.

<Effects>

As described above, the input switch SW301 is connected between the input latch and the output latch, so that the timing of data transfer from the output latch to the decoder and the timing of outputting data to the output node can be controlled. Therefore, the possibility of an error occurring in the decoder can be eliminated. Thus, a stable output to the display panel can be realized, and a voltage driver capable of operating more stably can be provided.

It should be noted that the supply switches SW201-1R to SW201-2B may be connected between the connection switches SW104R to SW104B and the operational amplifiers A105-1R to A105-2B as in FIG. 7. Alternatively, the supply switches SW201-1R to SW201-2B may be connected between the decoders D103-1R to D103-2B and the connection switches SW104R to SW104B as in FIG. 8.

(Embodiment 6)

<Structure>

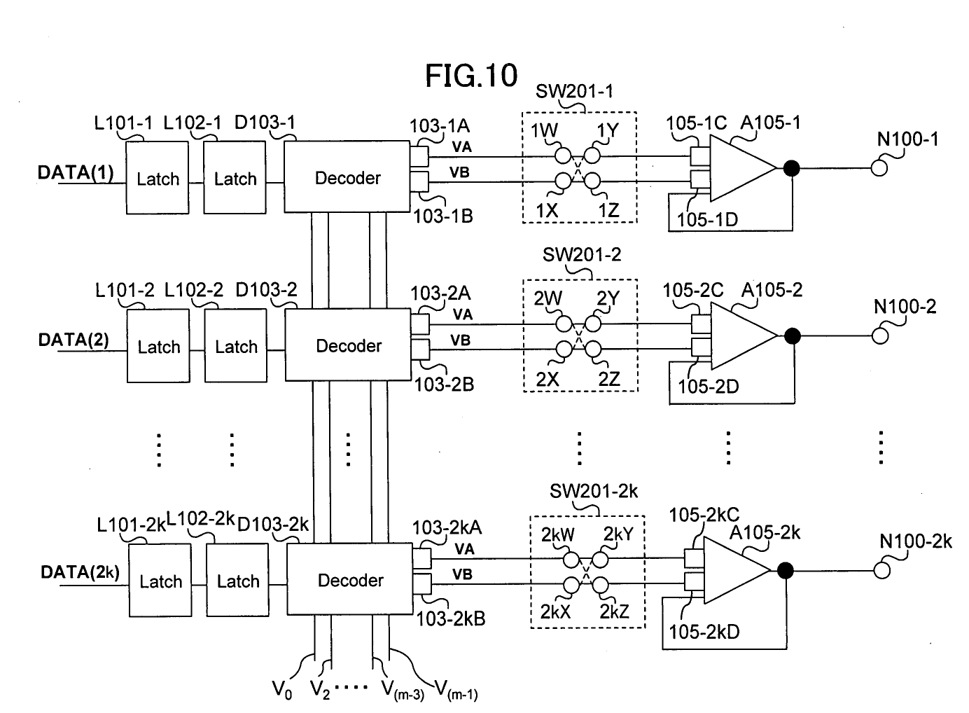

An overall structure of a voltage driver according to embodiment 6 of the present invention is illustrated in FIG. 10. This driver includes 2k supply switches SW201-1 to SW201-2k shown in FIG. 3 in place of the k connection switches SW104(1,2) to SW104(2k−1,2k) and the output switches SW106(1,2) to SW106(2k−1,2k) shown in FIG. 1. The other parts of the structure are the same as those of FIG. 1.

The supply switch SW201-1 has a terminal 1W connected to the output terminal 103-1A of the decoder D103-1, a terminal 1X connected to the output terminal 103-1B of the decoder D103-1, a terminal 1Y connected to the input terminal 105-1C of the operational amplifier A105-1, and a terminal 1Z connected to the input terminal 105-1D of the operational amplifier A105-1. In the other supply switches SW201-2 to SW201-2k, each terminal is also connected to an output terminal of a corresponding decoder or an input terminal of a corresponding operational amplifier as in the supply switch SW201-1.

This voltage driver is configured with the minimum unit including one input latch, one output latch, one decoder, one supply switch, and one operational amplifier. For example, an input latch L101-1, an output latch L102-1, a decoder D103-1, a supply switch SW201-1, and an operational amplifier A105-1 constitute a single minimum unit.

<Operation>

Next, an operation of the voltage driver shown in FIG. 10 is described. Herein, an operation relating to display data DATA(1) is described as a typical example.

[Normal Connection Mode]

When the normal connection mode is entered, in the supply switch SW201-1, the terminal 1W is connected to the terminal 1Y, and the terminal 1X is connected to the terminal 1Z. Accordingly, the input terminal 105-1C of the operational amplifier A105-1 is supplied with selection voltage VA from the output terminal 103-1A of the decoder D103-1. The input terminal 105-1D of the operational amplifier A105-1 is supplied with selection voltage VB from the output terminal 103-1B of the decoder D103-1.

[Cross-connection Mode]

When the cross-connection mode is entered, in the supply switch SW201-1, the terminal 1W is connected to the terminal 1Z, and the terminal 1X is connected to the terminal 1Y. Accordingly, the input terminal 105-1C of the operational amplifier A105-1 is supplied with selection voltage VB from the output terminal 103-1B of the decoder D103-1. The input terminal 105-1D of the operational amplifier A105-1 is supplied with selection voltage VA from the output terminal 103-1A of the decoder D103-1.

<Variations>

Where an error in selection voltage VA output from the output terminal 103-1A of the decoder D103-1 is ΔVA and an error in selection voltage VB output from the output terminal 103-1B of the decoder D103-1 is ΔVB, in the operational amplifier A105-1,
the error in the selection voltage received by the transistor TT1=(ΔVA+ΔVB)/2, and
the error in the selection voltage received by the transistor TT2=(ΔVA+ΔVB)/2.
That is, the errors in the selection voltages received by the two input terminals 105-1A and 105-1B of the operational amplifier A105-1 are averaged to be equal to each other.

<Effects>

As described above, the selection voltages input to the input terminals of the operational amplifier can be averaged, and therefore, the errors in driving voltages output from the operational amplifiers can be averaged. Thus, the evenness in display quality can be further improved as compared with the conventional voltage drivers.

A voltage driver of the present invention is useful for a display driver for driving liquid crystals of a liquid crystal panel, or the like.

What is claimed is:

1. A voltage driver, comprising:
a first decoder for outputting two selection voltages according to first gray-level data;
a second decoder for outputting two selection voltages according to second gray-level data;
first and second differential amplifier circuits;
a first connection switching circuit for associating one of the first and second decoders with the first differential amplifier circuit and the other decoder with the second differential amplifier circuit; and
an output switching circuit for associating one of the first and second differential amplifier circuits with a first output node and the other differential amplifier circuit with a second output node in conjunction with the association by the first connection switching circuit,
wherein each of the first and second decoders selects any one of a plurality of gray-level voltages according to the gray-level data to output, as the two selection voltages, two voltages each having a voltage value equal to the selected gray-level voltage or selects any two of the plurality of gray-level voltages according to the gray-level data to output the two selected gray-level voltage as the two selection voltages, and
each of the first and second differential amplifier circuits synthesizes two selection voltages from the decoder associated with the differential amplifier circuit by the first connection switching circuit at a predetermined ratio to generate a driving voltage and outputs the generated driving voltage to the output node associated with the differential amplifier circuit by the output switching circuit.

2. The voltage driver of claim 1, wherein:
each of the first connection switching circuit and the output switching circuit has a first connection mode and a second connection mode;
in the first connection mode,
the first connection switching circuit associates the first decoder with the first differential amplifier circuit and associates the second decoder with the second differential amplifier circuit, and
the output switching circuit associates the first differential amplifier circuit with the first output node and associates the second differential amplifier circuit with the second output node; and
in the second connection mode,
the first connection switching circuit associates the first decoder with the second differential amplifier circuit and associates the second decoder with the first differential amplifier circuit, and
the output switching circuit associates the first differential amplifier circuit with the second output node and associates the second differential amplifier circuit with the first output node.

3. The voltage driver of claim 1, wherein:
the first connection switching circuit includes a first input section for receiving two selection voltages from the first decoder, a second input section for receiving two selection voltages from the second decoder, a first output section for outputting the two selection voltages received by one of the first and second input sections, and a second output section for outputting the two selection voltages received by the other one of the first and second input sections;
the first differential amplifier circuit receives the two selection voltages from the first output section of the first connection switching circuit; and
the second differential amplifier circuit receives the two selection voltages from the second output section of the first connection switching circuit.

4. The voltage driver of claim 1, further comprising:
a first output latch for acquiring the first display data;
a second output latch for acquiring the second display data;
a third output latch for acquiring third display data;
a fourth output latch for acquiring fourth display data;
a fifth output latch for acquiring fifth display data;
a sixth output latch for acquiring sixth display data;
third to sixth decoders;
an input switching circuit for associating the first to sixth output latches with the first to sixth decoders on a one-to-one basis;
third to sixth differential amplifier circuits;
a second connection switching circuit for associating one of the third and fourth decoders with the third differential amplifier circuit and associating the other decoder with the fourth differential amplifier circuit; and
a third connection switching circuit for associating one of the fifth and sixth decoders with the fifth differential amplifier circuit and associating the other decoder with the sixth differential amplifier circuit,
wherein the output switching circuit associates the first to sixth differential amplifier circuits with the first and second output nodes and third to sixth output nodes on a one-to-one basis in conjunction with the association by the input switching circuit and the association by the first to third connection switching circuits,
each of the first to sixth decoders selects any one of a plurality of gray-level voltages according to gray-level data acquired by the output latch associated with the decoder by the input switching circuit to output two voltages each having a voltage value equal to the selected gray-level voltage as two selection voltages or selects any two of the plurality of gray-level voltages according to the gray-level data acquired by the output latch associated with the decoder by the input switching circuit to output the two selected gray-level voltages as the two selection voltages,
each of the first and second differential amplifier circuits synthesizes two selection voltages from the decoder associated with the differential amplifier circuit by the first connection switching circuit at a predetermined ratio to generate a driving voltage and outputs the generated driving voltage to the output node associated with the differential amplifier by the output switching circuit,
each of the third and fourth differential amplifier circuits synthesizes two selection voltages from the decoder associated with the differential amplifier circuit by the second connection switching circuit at a predetermined ratio to generate a driving voltage and outputs the generated driving voltage to the output node associated with the differential amplifier by the output switching circuit, and
each of the fifth and sixth differential amplifier circuits synthesizes two selection voltages from the decoder associated with the differential amplifier circuit by the third connection switching circuit at a predetermined ratio to generate a driving voltage and outputs the generated driving voltage to the output node associated with the differential amplifier by the output switching circuit.

5. The voltage driver of claim 4, wherein:
the first decoder and the second decoder are physically adjacent to each other;
the first differential amplifier circuit and the second differential amplifier circuit are physically adjacent to each other;
the input switching circuit has a first connection mode and a second connection mode such that, in the first connection mode, the input switching circuit associates the first output latch with the first decoder and the second output latch with the second decoder and, in the second connection mode, the input switching circuit associates the first output latch with the second decoder and the second output latch with the first decoder;
the first connection switching circuit has a third connection mode and a fourth connection mode such that, in the third connection mode, the first connection switching circuit associates the first decoder with the first differential amplifier circuit and the second decoder with the second differential amplifier circuit and, in the fourth connection mode, the first connection switching circuit associates the first decoder with the second differential amplifier and the second decoder with the first differential amplifier circuit;
the output switching circuit has a fifth connection mode and a sixth connection mode such that, in the fifth connection mode, the output switching circuit associates the first differential amplifier circuit with the first output node and the second differential amplifier circuit with the second output node and, in the sixth connection mode, the output switching circuit associates the first differential amplifier circuit with the second output node and the second differential amplifier circuit with the first output node;
when the input switching circuit is in the first connection mode and the first connection switching circuit is in the third connection mode or when the input switching circuit is in the second connection mode and the first connection switching circuit is in the fourth connection mode, the output switching circuit is in the fifth connection mode; and
when the input switching circuit is in the first connection mode and the first connection switching circuit is in the fourth connection mode or when the input switching circuit is in the second connection mode and the first connection switching circuit is in the third connection mode, the output switching circuit is in the sixth connection mode.

6. The voltage driver of claim 1, further comprising:
a first input latch for acquiring the first gray-level data;
a second input latch for acquiring the second gray-level data;
a third input latch for acquiring third gray-level data;
a fourth input latch for acquiring fourth gray-level data;
a fifth input latch for acquiring fifth gray-level data;
a sixth input latch for acquiring sixth gray-level data;
a first output latch corresponding to the first decoder,
a second output latch corresponding to the second decoder,
third to sixth output latches,
an input switching circuit for associating the first to sixth input latches with the first to sixth output latches on a one-to-one basis;
third to sixth decoders corresponding to the third to sixth latches on a one-to-one basis;
third to sixth differential amplifier circuits;
a second connection switching circuit for associating one of the third and fourth decoders with the third differential amplifier circuit and associating the other decoder with the fourth differential amplifier circuit; and
a third connection switching circuit for associating one of the fifth and sixth decoders with the fifth differential amplifier circuit and associating the other decoder with the sixth differential amplifier circuit,
wherein the output switching circuit associates the first to sixth differential amplifier circuits with the first and second output nodes and third to sixth output nodes on a one-to-one basis in conjunction with the association by the input switching circuit and the association by the first to third connection switching circuits,
each of the first to sixth output latches acquires gray-level data acquired by an input latch associated by the connection switching circuit in synchronization with a predetermined timing,
each of the first to sixth decoders selects any one of the plurality of gray-level voltages according to gray-level data acquired by the output latch associated with the decoder by the input switching circuit to output two voltages each having a voltage value equal to the selected gray-level voltage as the two selection voltages or selects any two of the plurality of gray-level voltages according to the gray-level data acquired by the output latch associated with the decoder by the input switching circuit to output the two selected gray-level voltages as the two selection voltages,
each of the first and second differential amplifier circuits synthesizes two selection voltages from the decoder associated with the differential amplifier circuit by the first connection switching circuit at a predetermined ratio to generate a driving voltage and outputs the generated driving voltage to the output node associated with the differential amplifier by the output switching circuit,
each of the third and fourth differential amplifier circuits synthesizes two selection voltages from the decoder associated with the differential amplifier circuit by the second connection switching circuit at a predetermined ratio to generate a driving voltage and outputs the generated driving voltage to the output node associated with the differential amplifier by the output switching circuit, and
each of the fifth and sixth differential amplifier circuits synthesizes two selection voltages from the decoder associated with the differential amplifier circuit by the third connection switching circuit at a predetermined ratio to generate a driving voltage and outputs the generated driving voltage to the output node associated with the differential amplifier by the output switching circuit.

7. The voltage driver of claim 6, wherein:
the first decoder and the second decoder are physically adjacent to each other;
the first differential amplifier circuit and the second differential amplifier circuit are physically adjacent to each other;
the input switching circuit has a first connection mode and a second connection mode such that, in the first connection mode, the input switching circuit associates the first input latch with the first output latch and the second input latch with the second output latch and, in the second connection mode, the input switching circuit associates the first input latch with the second output latch and the second input latch with the first output latch;
the first connection switching circuit has a third connection mode and a fourth connection mode such that, in the third connection mode, the first connection switching circuit associates the first decoder with the first differential amplifier circuit and the second decoder with the second differential amplifier circuit and, in the fourth connection mode, the first connection switching circuit associates the first decoder with the second differential amplifier and the second decoder with the first differential amplifier circuit;
the output switching circuit has a fifth connection mode and a sixth connection mode such that, in the fifth connection mode, the output switching circuit associates the first differential amplifier circuit with the first output node and the second differential amplifier circuit with the second output node and, in the sixth connection mode, the output switching circuit associates the first differential amplifier circuit with the second output node and the second differential amplifier circuit with the first output node;
when the input switching circuit is in the first connection mode and the first connection switching circuit is in the third connection mode or when the input switching circuit is in the second connection mode and the first connection switching circuit is in the fourth connection mode, the output switching circuit is in the fifth connection mode; and
when the input switching circuit is in the first connection mode and the first connection switching circuit is in the fourth connection mode or when the input switching circuit is in the second connection mode and the first connection switching circuit is in the third connection mode, the output switching circuit is in the sixth connection mode.

8. The voltage driver of claim 1, wherein:
each of the first and second decoders has a first output terminal for outputting one of the two selection voltages and a second output terminal for outputting the other of the two selection voltages;
each of the first and second differential amplifier circuits has first and second input terminals and synthesizes a selection voltage input at the first input terminal and a selection voltage input at the second input terminal at a predetermined ratio to generate a driving voltage; and
the driver further includes a first supply switching circuit which operates between one of the first and second decoders and a differential amplifier circuit associated with the decoder by the first connection switching circuit such that the first supply switching circuit supplies a selection voltage output from one of first and second output terminals of the decoder to a first input terminal of the differential amplifier circuit and supplies a selection voltage output from the other output terminal of the decoder to a second input terminal of the differential amplifier circuit.

9. The voltage driver of claim 8, wherein:
the first supply switching circuit has a first connection mode and a second connection mode;
in the first connection mode, the first supply switching circuit operates between one of the first and second decoders and a differential amplifier circuit associated with the decoder by the first connection switching circuit such that the first supply switching circuit supplies a selection voltage output from a first output terminal of the decoder to a first input terminal of the differential amplifier circuit and supplies a selection voltage output from a second output terminal of the decoder to a second input terminal of the differential amplifier circuit; and
in the second connection mode, the first supply switching circuit operates between one of the first and second decoders and a differential amplifier circuit associated with the decoder by the connection switching circuit such that the first supply switching circuit supplies a selection voltage output from a first output terminal of the decoder to a second input terminal of the differential amplifier circuit and supplies a selection voltage output from a second output terminal of the decoder to a first input terminal of the differential amplifier circuit.

10. The voltage driver of claim 8, further comprising a second supply switching circuit which operates between the other one of the first and second decoders and a differential amplifier circuit associated with the decoder by the first connection switching circuit such that the second supply switching circuit supplies a selection voltage output from one of first and second output terminals of the decoder to a first input terminal of the differential amplifier circuit and supplies a selection voltage output from the other output terminal of the decoder to a second input terminal of the differential amplifier circuit.

11. A voltage driver, comprising:
a decoder for generating two selection voltages according to gray-level data and outputting one of the two generated selection voltages from a first output terminal and the other selection voltage from a second output terminal;
a differential amplifier circuit having first and second input terminals for generating a driving voltage by synthesizing a voltage input at the first input terminal and a voltage input at the second input terminal at a predetermined ratio and outputting the generated driving voltage; and
a supply switching circuit for supplying a selection voltage output from one of the first and second output terminals of the decoder to the first input terminal of the differential amplifier circuit and supplying a selection voltage output from the other output terminal of the decoder to the second input terminal of the differential amplifier circuit,
wherein the decoder selects any one of a plurality of gray-level voltages according to the gray-level data to output two voltages each having a voltage value equal to the selected gray-level voltage as the two selection voltages or selects any two of the plurality of gray-level voltages according to the gray-level data to output the two selected gray-level voltages as the two selection voltages.

12. The voltage driver of claim 11, wherein:
the supply switching circuit has a first connection mode and a second connection mode;
in the first connection mode, the supply switching circuit supplies a selection voltage output from a first output terminal of the decoder to a first input terminal of the differential amplifier circuit and supplies a selection voltage output from a second output terminal of the decoder to a second input terminal of the differential amplifier circuit; and
in the second connection mode, the supply switching circuit supplies a selection voltage output from a first output terminal of the decoder to a second input terminal of the differential amplifier circuit and supplies a selection voltage output from a second output terminal of the decoder to a first input terminal of the differential amplifier circuit.
